(19) United States
(12) Patent Application Publication
(10) Pub. No.: US 2026/0320922 A1
(43) Pub. Date: Oct. 15, 2026

(54) METHODS AND SYSTEMS FOR UPDATING RENDERINGS OF THREE-DIMENSIONAL (3D) OBJECTS

(71) Applicant: GOOGLE LLC, Mountain View, CA (US)

(72) Inventors: Douglas Sim Dietrich, Jr., Los Gatos, CA (US); Erik Frances Nelson, Sunnyvale, CA (US)

(21) Appl. No.: 19/473,795

(22) PCT Filed: Apr. 13, 2023
(86) PCT No.: PCT/US2023/018572

§ 371 Date: Oct. 8, 2025

(51) Int. Cl. G06T 19/00; G06T 13/40

(52) U.S. Cl. CPC G06T 19/00; G06T 13/40

(57) ABSTRACT

A method and system are disclosed for updating renderings of three-dimensional (3D) objects. A first rendering of a first 3D object and a second rendering of a second 3D object is provided to a client device. One or more requests are received for a first update to the first rendering of the first 3D object and a second update to a second rendering of the second 3D object. A first update priority score is determined for the first update and a second update priority score is determined for the second update. At least one of the first rendering of the first 3D object or the second rendering of the second 3D object is updated based on the first update priority score for the first update and the second update priority score for the second update.

### TECHNICAL FIELD

Aspects and implementations of the present disclosure updating renderings of three-dimensional (3D) objects.

### BACKGROUND

Computer animation refers to the process of digitally generating animation. In an illustrative example, objects (models) are built on the computer monitor and three-dimensional (3D) models are rigged with a virtual skeleton. The limbs, eyes, mouth, clothes, etc. of the object can be moved by the animator on key frames. The differences in appearance between key frames are automatically calculated by the computer and then the animation is rendered.

The 3D animated objects can be used by certain applications, such as video games in virtual reality (VR), applications in augmented reality (AR), avatars in certain programs, etc., to represent the objects to a user. In one example, a sports game played by a user in a virtual reality environment may require the generation of a virtual field, equipment, and players. In some instances, 3D objects associated with respective client devices can interact with each other (e.g., in a virtual space provided by a platform). For example, a virtual avatar associated with a particular client device can interact with virtual avatars associated with other client devices during a virtual meeting, a virtual concert, a virtual sportingevent, a virtual party, etc. The animation of each 3D object in a virtual space may be independently controlled via the client device associated with the 3D object. A platform that is providing the virtual space may receive a request from a particular client device to update the rendering of the 3D object (e.g., in response to a user interacting with one or more control elements of the particular client device). The platform may update the rendering of the 3D object on each client device accessing the virtual space to reflect the requested update from the particular client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosurein a simplified form as a prelude to the more detailed description that is presented later.

An aspect of the disclosure provides a computer-implemented method that includes providing, by a processing device, a first rendering of a first three-dimensional (3D) object and a second rendering of a second 3D object to a client device. The method further includes receiving, by the processing device, one or more requests for a first update to the firstrendering of the first 3D object and a second update to the second rendering of the second 3D object/the method further includes determining, by the processing device, a first update priority score for the first update and a second update priority score for the second update. The method further includes updating, by the processing device, at least one of the first rendering of the first 3D object or the second rendering of the second 3D object based on the first update priority score for the first update and the second update priority score for the second update.

In some aspects of the disclosure, the first 3D object and the second 3D object are included in a virtual space that includes a third 3D object associated with the client device. Determining the first update priority score for the first update and the second update priority score for the second update can include determining a first level of visibility of the first 3D object from a vantage point of the third 3D object and a second level of visibility of the second 3D object from the vantage point of the third 3D object. The first update priority score determined for the first update exceeds the second update priority score determined for the second update responsive to the first level of visibility exceeding the second level of visibility.

In some aspects of the disclosure, the computer-implemented method further includes receiving, from the client device, a prediction made by the client device of one or more updates to at least one of the first rendering of the first 3D object or the second rendering of the second 3D object. The method further includes comparing the one or more updates of the prediction made by the client device to at least one of the first update to the first rendering of the first 3D object or the second update to the second rendering of the second 3D object. The method further includes determining an accuracy of the prediction made by the client device based on the comparison of the one or more updates to the at least one of the first update to the first rendering of the 3D object or the second update to the second rendering of the second 3D object. One or more of the first update priority score or the second update priority score is determined based on the determined accuracy. In some aspects, the prediction made by the client device is obtained based on one or more machine learning models associated with the client device. The method can further include responsive to determining that the accuracy of the prediction made by the client device does not meet an accuracy threshold, providing an indication of the first update to the first rendering of the first 3D object to the client device for training the one or more machine learning models associated with the client device.

In some aspects, determining the first update priority score for the first update and the second update priority score for the second update can include providing first data associated with the first update and second data associated with the second update as input to a machine learning model, wherein the machine learning model is trained to indicate, based on given input data associated with updates to renderings of 3D objects, an update priority score for updating the renderings of the 3D objects at client devices connected to a platform, obtaining one or more outputs of the machine learning model, and extracting the first update priority score and the second update priority score from the one or more outputs of the machine learning model. The first 3D object can be associated with a first additional client device connected to a platform via a network and is included in a virtual space that includes one or more other 3D objects, the one or more other 3D objects including at least the second 3D object. The first data associated with the first update can include one or more of: a level of visibility of the first 3D object from a vantage point of at least one of the one or more other 3D objects, a time period since the first rendering of the first 3D object has been updated for the client device, a number of 3D objects of the one or more other 3D objects having vantage points that include the first 3D object, a degree of motion associated with the first update to the rendering of the first 3D object in the virtual space, an audio level of audio associated with the first 3D object, a distance between the first 3D object and the one or more other 3D objects in the virtual space, a distance between the first 3D object and a 3D object of interest by the one or more other 3D objects in the virtual space, or an accuracy of a prediction by the client device of a motion of the first 3D object.

In some aspects, updating at least one of the first rendering of the first 3D object or the second rendering of the second 3D object based on the first update priority score for the first update and the second update priority score for the second update includes adding the first update and the second update to an update queue associated with the client device, wherein the firstupdate and the second update are added to the update queueaccording to an ordering based on the first update priority score and the second update priority score, and executing one or more operations to update the at least one of the first rendering of the first 3D object or the second rendering of the second 3D object according to the ordering of the update queue. The first update priority score for the first update can exceed the second update priority score for the second update. The first update can be added to a region of the update queue associated with a higher ordering than a region of the update queue to which the second update is added. In further aspects, updating at least one of the first rendering of the first 3D object based on the first update or the second rendering of the second 3D object based on the second update according to the ordering of the update queue includes updating the first rendering of the first 3D object based on the first update prior to updating the second rendering of the second 3D object based on the second update. In additional or alternative aspects, the method further includes receiving an additional request for a third update to the first rendering of the first 3D object, determining a third update priority score for the third update, removing the first update from the update queue, and adding the third update to the update queue according to the ordering based on the third update priority score.

In some aspects, the first 3D object includes a first component of a virtual avatar associated with an additional client device and the second 3D object includes a second component of the virtual avatar associated with the additional client device.

In some aspects, the first 3D object includes a first virtual avatar associated with a first additional client device connected to a platform and the second 3D object includes a second virtual avatar associated with a second additional client device connected to the platform.

An aspect of the disclosure provides a system including a memory and a processor communicatively coupled to the memory. The processor performs operations including providing a first rendering of a first three-dimensional (3D) object and a second rendering of a second 3D object to a client device. The operations further include receiving one or more requests for a first update to the first rendering of the first 3D object and a second update to the second rendering of the second 3D object. The operations further include determining a first update priority score for the first update and a second update priority score for the second update. The operations further include updating at least one of the first rendering of the first 3D object or the second rendering of the second 3D object based on the first update priority score for the first update and the second update priority score for the second update.

An aspect of the disclosure provides a non-transitory computer readable storage medium including instructions for a server that, when executed by a processing device, cause the processing device to perform operations including providing a first rendering of a first three-dimensional (3D) object and a second rendering of a second 3D object to a client device. The operations further include receiving one or more requests for a first update to the first rendering of the first 3D object and a second update to the second rendering of the second 3D object. The operations further include determining a first update priority score for the first update and a second update priority score for the second update. The operations further include updating at least one of the first rendering of the first 3D object or the second rendering of the second 3D object based on the first update priority score for the first update and the second update priority score for the second update.

An aspect of the disclosure provides a computer program including instructions that, when the program is executed by a computer, cause the computer to carry out a method that includes providing, by a processing device, a first rendering of a first three-dimensional (3D) object and a second rendering of a second 3D object to a client device. The method further includes receiving, by the processing device, one or more requests for a first update to the first rendering of the first 3D object and a second update to the second rendering of the second 3D object. The method further includes determining, by the processing device, a first update priority score for the first update and a second update priority score for the second update. The method further includes updating, by the processing device, at least one of the first rendering of the first 3D object or the second rendering of the second 3D object based on the first update priority score for the first update and the second update priority score for the second update.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example user management engine, and example model engine, and an example rendering engine, in accordance with some aspects of the present disclosure.

FIGS. 3A-3B illustrate example virtual spaces including 3D objects, in accordance with some aspects of the present disclosure.

FIG. 4 illustrates a flow diagram for an example method for updating renderings of three-dimensional (3D) objects at one or more client devices accessing a virtual space, in accordance with some aspects of the present disclosure.

FIG. 5 illustrates a flow diagram for an example method of improving an accuracy of predictions made by a prediction engine, in accordance with some aspects of the present disclosure.

FIG. 6 illustrates a flow diagram for an example method of determining an update priority score for an update to a rendering of a 3D object, in accordance with some aspects of the present disclosure.

FIG. 7 illustrates an example predictive system, in accordance with some aspects of the present disclosure.

FIG. 8 illustrates a flow diagram for another example method of determining an update priority score for an update to a rendering of a 3D object, in accordance with some aspects of the present disclosure.

FIG. 9 illustrates a flow diagram for an example method of training a machine learning model, in accordance with some aspects of the present disclosure.

FIG. 10 is a block diagram illustrating an exemplary computer system, in accordance with implementations of the present disclosure.

### DETAILED DESCRIPTION

Aspects of the present disclosure are directed to updating renderings of three-dimensional (3D) objects. Skeletal rigging is a technique in animation in which a 3D object (e.g., a character, an animal, a building, a vehicle, etc.) is represented in two parts. The first part includes a surface representation of the object, referred to as a polygon mesh, a mesh, or skin. The second part includes a hierarchical set of interconnected parts. The entirety of the hierarchical set is referred to as a skeleton structure, a skeleton, or a rig, while each part of the hierarchical set is referred to as a bone. The polygon mesh can include a collection of vertices, edges, and faces that define a shape of a polyhedral object. Specifically, the polygon mesh can include a set of poly gons composed to make up the surface for the object. For example, data representing the object can include an indication of a triangular mesh having a set of vertices that form triangles (and/or other attributes such as normals, color, or UV coordinates associated with corresponding texture images). The bones collectively form the skeleton or the rig, which is used as a virtual framework to animate the vertices of the polygons. The animation can be composed of key frames and in-between frames. The key frames represent markers or anchor points that define the start and end points for an action by the object. For example, the key frames can represent significant poses of a character's actions, such as the first and last positions of a jumping motion. In-between frames represent the poses between the key frames. That is, the in-between frames move the animation from one key frame to another.

A mesh for some regions of a 3D object can include a significant number of vertices that, when animated, depict a higher level of detail than other regions of the 3D object. For example, a mesh for a face of a virtual avatar can include a significant number of vertices that illustrate detail of the face (e.g., eyes, eye lashes, eye brows, nose, lips, etc.). Other types of animation can be used for rendering such regions of the 3D object, which can include blend shape animation (also referred to as morph target animation), per-vertex animation, and so forth. In blend shape animation, a “deformed” version of a mesh for a region of a 3D object is created (e.g., by an artist or a developer) as a series of vertex positions. Each “deformed” version of the mesh is referred to as a respective blend shape or a respective morph target. In an example of a face for a virtual avatar, an artist can create (e.g., using computer animation tools) a blend shape representing a neutral expression of the virtual avatar, a blend shape representing a smiling mouth of the virtual avatar, a blend shape representing one or more closed or open eyes of the virtual avatar, a blend shape representing a raised eyebrow of the virtual avatar. In each key frame of an animation, position of each vertex of the mesh is interpolated based on weights of each blend shape.

In some systems, a platform (e.g., a content sharing platform, a virtual environment platform, etc.) can provide a rendering of a virtual space to one or more client devices connected to the platform (e.g., via a network). A virtual space (also referred to as a virtual reality, a virtual environment, etc.) refers to a simulated space or environment (e.g., a computer simulated space or environment) with which users can interact via an interface. In one example, a virtual space can include virtual meeting space, a virtual concert space, a virtual sporting event space, etc. that can be accessed by one or more client devices connected to a platform (e.g., via a network). A 3D object associated with a client device accessing the virtual space can be included in the virtual space and, in some instances, can represent the client device and/or a user of the client device in the virtual space. For example, a user associated with a client device can request access to a virtual concert space provided by the platform. The platform and/or the client device can update the virtual concert space to include a rendering of a virtual avatar associated with the user, as requested by the user. In some instances, client devices accessing the virtual space can interact with other client devices accessing the virtual space via 3D objects associated with the client devices. In one example, a user can interact or otherwise interface with another user of the platform by causing a virtual avatar associated with the user to interact with (e.g., talk to, engage with, etc.) a virtual avatar associated with another user of the platform (e.g., as requested by the other user of the platform).

An animation of a 3D object can be controlled by a client device associated with the 3D object, in some instances. For example, a user associated with a client device can engage with one or more control elements (e.g., user interface (UI) elements, elements of a peripheral device, etc.) to request a change or an update in an animation of a virtual avatar associated with the client device in the virtual space. In response to detecting a request to update the animation of the virtual avatar, the client device can forward the request (also referred to as an update request) to the platform. The platform can transmitinstructions to other client devices accessing the virtual space to cause the other client devices to update the rendering of the virtual avatar associated with the client device, in accordance with the update request. In some instances, rendering engines of each client device can update the rendering of the virtual avatar based on the received instructions from the platform and can provide the updated rendering to users of the other client devices (e.g., via a UI of the other client devices).

In conventional systems, a platform can transmit instructions to each client device accessing a virtual space responsiveto each update request received for 3D objects in the virtual space. In some instances, a virtual space can include a large number of 3D objects each associated with a respective client device. For example, a virtual meeting space and/or a virtual party space (or other such type of virtual space) can include tens or hundreds of virtual avatars each associated with respective client devices that are accessing the virtual meeting space and/or the virtual party space. In another example, a virtual concert space and/or virtual sporting event space (or other such type of virtual space) can include hundreds, thousands, or more virtual avatars each associated with respective client devices that are accessing the virtual concert space and/or virtual sporting event space. Throughout a time period that client devices are accessing the virtual space, each client device can transmit multiple update requests to update avatars associated with the respective client device (e.g., based on user interaction with control elements of the client devices). In some instances, one or more client devices can transmit a large number of update requests during the time period that client devices are accessing the virtual space. The platform can therefore transmit multiple instructions to the other client devices accessing the virtual space to cause the client devices to update the renderings of the 3D objects associated with such client devices. As such, the processing network and data storage resource consumed to achieve the updates, particularly within an acceptable update time, may be onerous.

In some instances, an update to a particular 3D object may not be detectable or may be barely noticeable to a user accessing the virtual space via a connected client device. For example, a first virtual avatar (e.g., associated with a first user) may be facing a second virtual avatar (e.g., associated with a second user) in a virtual meeting space. A third virtual avatar (e.g., associated with a third user) may be facing away from the first virtual avatar and the second virtual avatar and/or may be located at a particular distance away from the first virtual avatar and the second virtual avatar so that the first user and/or second user may not detect details (e.g., facial expressions, arm or leg movements, etc.) of the rendering of the third virtual avatar. In another example, a virtual space can be a virtual concert space that includes a performer virtual avatar (e.g., representing a performer of a virtual concert) and multiple audience virtual avatars (e.g., representing audience members of the virtual concert). The performer virtual avatar may face the audience virtual avatars during the virtual concert, but may notbe able to detect details (e.g., facial expressions) of one or more of the audience virtual avatars (e.g., audience virtual avatars that are farthest away from the performer virtual avatar in the virtual concert space). The audience virtual avatars may each be facing the performer virtual avatar (e.g., to enable associated users to view the performance by the performer virtual avatar during the virtual concert). The audience virtual avatars may not transition focus from the performer virtual avatar to any (or at least a portion of) the audience virtual avatars during the virtual concert.

As indicated above, in conventional systems, a platform (or other computing system providing client devices with access to a virtual space or virtual event) provides instructions to each client device accessing a virtual space in response to each request by client devices to update the animations of 3D objects in the virtual space. As also indicated above, a virtual space can include tens, hundreds, thousands, etc. of 3D objects, in some instances, and users associated with the 3D objects may not detect or may not notice the details of each 3D object in the virtual space. Accordingly, some requested updates to the rendering of a 3D object may not impact the experience of a user of a client device accessing the virtual space, as the user may not be able to detect or may not notice the updates made to some 3D objects in the virtual space. Transmitting instructions to update renderings of 3D objects to each client device can consume a large amount of computing resources of the platform (e.g., processing cycles, etc.) and can consume a large amount of network bandwidth. In addition, client devices can consume a large amount of computing resources (e.g., processing cycles, device power, etc.) to update a rendering of a 3D object. Computing resources (e.g., of the platform and/or of the client device) that are used to update renderings of 3D objects that ultimately will not be detected or noticeable by users accessing the virtual space are thus made unavailable to other processes of the computing system (e.g., of the platform and/or the client device). The unavailability of computingresources to the computing system can cause an increase in an overall latency of the computing system and/or a decrease in the overall efficiency of the computing system.

Implementations of the present disclosure address the above and other deficiencies by providing techniques for updating renderings of three-dimensional (3D) objects. A platform can provide one or more client devices with access to a virtual space (e.g., via a network), in some embodiments. In some embodiments, the virtual space can include a rendering of a 3D object associated with each client device that is accessing the virtual space. In some embodiments, a 3D object can correspond to a virtual avatar associated with a client device that is accessing the virtual space. In other or similar embodiments, a 3D object can correspond to a component of a virtual avatar.

As client devices access the virtual space, a client device can transmit a request to the platform to update a rendering of a 3D object associated with the client device at other client devices that are accessing the virtual space. Such request is also referred to as an “update request” herein. In an illustrative example, a first client device (e.g., associated with a first user) and a second client device (e.g., associated with a second user) can access a virtual space (e.g., a virtual meeting space, a virtual party space, a virtual concert space, etc.) provided by the platform. The first client device can transmit a request to the platform to update a rendering of a 3D object (e.g., a virtual avatar) associated with the first client device (e.g., based on a user interaction of one or more control elements of the first client device) on at least the second client device accessing the virtual space. In response to receiving an update request from a client device, the platform can determine one or more update priority scores for the update request. A priority score refers to a metric indicating a priority that an update to a rendering of a 3D object has relative to other updates to renderings of 3D objects that are requested by the platform. In some embodiments, the platform can determine an update priority score for updating the 3D object at each client device accessing the virtual space. The update priority score can be determined based on one or more update factors for each client device accessing the virtual space, in some embodiments. For example, the platform can determine an update priority score for updating the 3D object at a respective client device based on at least one of a level of visibility of the 3D object of the update request from a vantage point of one or more additional 3D objects associated with the respective client device, a time period since the rendering of the 3D object of the update request has been updated at the respective client device, a number of additional 3D objects in the virtual space having vantage points that include the 3D object of the update request, a degree of motion associated with the update to the rendering of the 3D object of the update request in the virtual space, an audio level of an audio associated with the 3D object of the update request provided by the client device that transmitted the update request to the platform, a distance between the 3D object of the update request and one or more additional 3D objects in the virtual space, a distance between the 3D object and an object of interest by one or more other 3D objects in the virtual space, and/or an accuracy of a prediction by the respective client device of a motion of the 3D object of the update request.

In an illustrative example, the platform can determine the priority score for an update to a 3D object of an update request by determining a level of visibility of the 3D object from a vantage point of another 3D objectin the vantage point. In some embodiments, the level of visibility can correspond to a degree of which a user associated with the other 3D object can perceive the 3D object of the update request and/or details of the 3D object of the update request. The level of visibility of the 3D object may be high if the 3D object is in the vantage point of the other 3D object (e.g., the 3D object is in front of the other 3D object) and/or is located within a threshold distance from the other 3D object. The level of visibility of the 3D object may be low if the 3D object is outside of the vantage point of the other 3D object and/or is located outside of the threshold distance from the other 3D object.

In another illustrative example, the platform can determine the priority score for an update to a 3D object based on an accuracy of predictions made by the respective client device of updates to the rendering of the 3D object in the virtual space. In some instances, one or more client devices accessing the virtual space can include a prediction engine that accesses a machine learning model (referred to as a 3D object prediction model). The 3D object prediction model can run on the respective client device or on a computing system that is accessible to the respective client device, in some embodiments. The 3D object prediction model can be trained to predict an update to be made to one or more 3D objects in a virtual space, in some embodiments. In some embodiments, the respective client device can obtain a prediction of an update to be made to one or more 3D objects in a virtual space and can provide an indication of the obtained prediction to the platform. The platform can compare the update to the 3D object of the update request to the prediction obtained by the respective client device and can determine an accuracy of the prediction obtained by the respective client device based on the comparison. In some embodiments, the platform can assign a high priority score to the update of the update request in response to determining that the prediction has a low accuracy (e.g., the prediction does not correspond to the requested update of the 3D object). In additional or alternative embodiments, the platform can assign a low priority score to the update of the update request in response to determining that the prediction has a high accuracy (e.g., the prediction corresponds to the requested update of the 3D object).

In yet another illustrative example, platform can determine the update priority score for an update to a 3D object of an update request based on an output of a machine learning model trained to predict the update priority score for updates to 3D objects in the virtual space. Such model is referred to herein as the update priority prediction model. The platform can obtain data associated with the update to the 3D object of the update request and/or the client device associated with the 3D object. The obtained data can include any data associated with the 3D object (e.g., a level of visibility of the 3D object, a time period since the rendering of the 3D object has been updated for the respective client device, etc.), as described above. In some embodiments, the platform can provide the obtained data as input to the update priority prediction model and can obtain one or more outputs of the model. The platform can extract an update priority score for the update from the one or more outputs of the machine learning model in some embodiments.

The platform can determine the update priority score for updating the rendering of the 3D object of the update request, as described above. In some embodiments, a high update priority score can indicate that the update of an update request has a higher priority than other updates that are requested of the platform (e.g., by other client devices), and a low update priority score can indicate that the update of the update request has a lower priority than the other updates requested of the platform. In some embodiments, the platform can add the update of the update request to an update queue associated with the respective client device. An update queue for a client device can include updates to one or more 3D objects of the virtual space. The platform can transmit instructions to the respective client device to update renderings of one or more 3D objects in accordance with an ordering of updates in the update queue. For example, the platform can transmit instructions for updates that are at or close to a head of the update queue before transmitting instructions for updates that are at or close to a tail of the update queue. The platform can remove an update from the update queue after instructions for the update are transmitted to the respective client device, in some embodiments. In some embodiments, the platform can determine that an update priority score for an update is below a threshold priority score and may not add the update to the priority queue.

In some embodiments, the update queue for the respective client device can include updates for one or more 3D objects (e.g., other than the 3D object of the update request). Each update of the update queue can be added to the update queue according to a priority score determined for the update, as described above. In some embodiments, the platform can add the update to the priority queue based on the determined update priority score determined for the update, as described above. For example, if the determined update priority score for the update of the update request exceeds the update priority scores for other updates in the update queue, the platform can add the update at or closer to a head of the update queue (e.g., than the other updates). If the determined update priority score for the update of the update request is smaller than the update priority scores for the other updates in the update queue, the platform can add the update at or closer to the tail of the update queue (e.g., than the other updates). The platform can transmit instructions to the respective client device according to an ordering of updates of the update queue, as described above.

Accordingly, aspects of the present disclosure provide techniques for enabling computing systems to prioritize updates to renderings of 3D objects that will be detectable or noticed by users of client devices accessing a virtual space including the 3D objects. The platform can assign an update priority score for updates of each update request received from client devices accessing the virtual spaces based on factors indicating whether a user of a client device will detect or notice details of an update to a 3D object. The platform can assign a high priority score to an update associated with factors that indicate the user will detect or notice details of the update and a low priority score to an update associated with factors that indicate the user will not detect or notice details of the update. Updates can be added to an update queue for the client device based on the assigned update priority score, and the platform can transmit instructions to client devices to update renderings of the 3D objects in accordance with an ordering of the update queue. Accordingly, the platform can transmit instructions to a client device to update rendering of 3D objects that are likely to be detected or noticed by the user associated with the client device prior to updating renderings of 3D objects that are not likely to be detected or noticed by the user. In some embodiments, the platform may not transmit instructions to a client device for an update having a priority score below a threshold priority score. Thus, instructions for updates that are not likely to impact a user experience with accessing the virtual space may not be sent to client devices and/or may be de-prioritized over updates that are likely to impact the user experience. As fewer instructions are sent to client devices accessing the virtual space, fewer computing resources are consumed by the platform and/or the client devices and more network bandwidth is available on the network between the platform and the client devices. As fewer computing resources are consumed by the platform and/or the client devices, more resources are available to other processes of the system, which improves an overall efficiency and/or decreases an overall latency of the system.

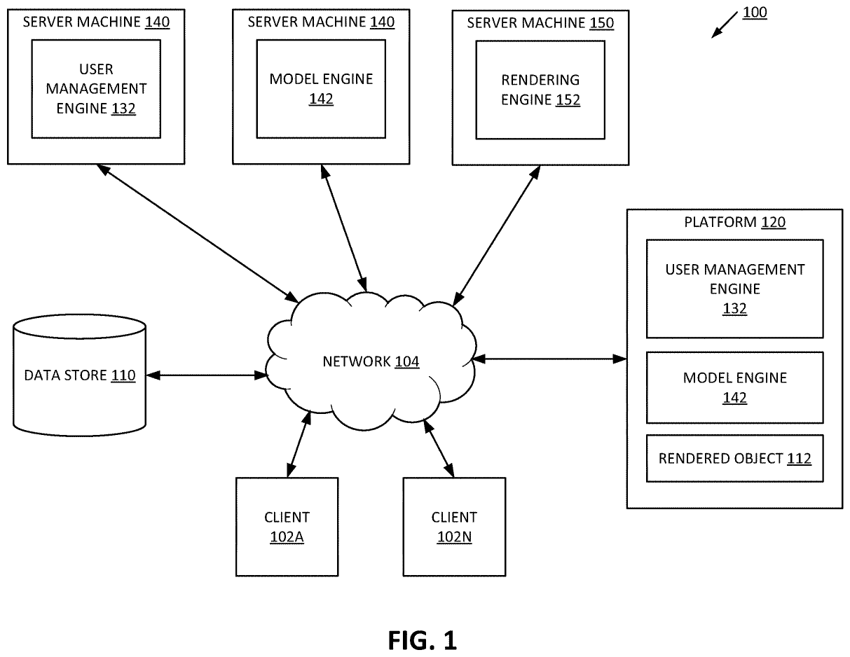

FIG. 1 illustrates an example system architecture 100, in accordance with implementations of the present disclosure. The system architecture 100 (also referred to as “system” herein) includes client devices 102A-N, a data store 110, a platform 120 (e.g., a content sharing platform), and/or one or more server machines 130-150, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

The client devices 102A-N (collectively and individually referred to as client device(s) 102 herein) may each include computing devices such as personal computers (PCs), laptops, mobile phones, smart phones, tablet computers, netbook computers, network-connected televisions, etc. In some implementations, client devices 102A-N may also be referred to as “user devices.” Each client device may include a content viewer. In some implementations, a content viewer may be an application that provides a user interface (UI) for users to view or upload content, such as images, video items, web pages, documents, etc. For example, the content viewer may be a web browser that can access, retrieve, present, and/or navigate content (e.g., web pages such as Hyper Text Markup Language (HTML) pages, digital media items, etc.) served by a web server. The content viewer may render, display, and/or present the content to a user. The content viewer may also include an embedded media player (e.g., a Flash® player or an HTML5 player) that is embedded in a web page (e.g., a web page that may provide information about a product sold by an online merchant). In another example, the content viewer may be a standalone application (e.g., a mobile application or app) that allows users to view digital media items (e.g., digital video items, digital images, electronic books, etc.).

In some embodiments, platform 120 can provide one or more client devices 102 with access to an application (not shown) associated with 3D objects. The application can provide one or more 3D objects (e.g., virtual avatars) for display via a UI of client device(s) 102. Data store 110 can store data associated with rendering the object, in some embodiments. In some implementations, data store 110 is a persistent storage that is capable of storing data as well as data structures to tag, organize, and index the data. Data store 110 may be hosted by one or more storage devices, such as main memory, magnetic or optical storage based disks, tapes or hard drives, NAS, SAN, and so forth. In some implementations, data store 110 may be a network-attached file server, while in other embodiments data store 110 may be some other type of persistent storage such as an object-oriented database, a relational database, and so forth, that may be hosted by platform 120 or one or more different machines coupled to platform 120 via network 104.

In some embodiments, the 3D objects provided by the application can be or correspond to virtual avatars associated with one or more users of platform 120. A virtual avatar refers to a virtual character or representation associated with a user. The user can control the virtual avatar (e.g., via an associated client device 102) and/or can interact with virtual avatars associated with other users via the application. In some embodiments, the virtual avatar associated with the user can be generated based on image data (e.g., photos, video data, etc.) provided to platform 120 (e.g., by the user) and can depict one or more characteristics of the user. In other or similar embodiments, the virtual avatar can depict one or more characteristics of a character selected by the user. It should be noted that embodiments of the present disclosure apply to any type of virtual avatar and/or any type of 3D object.

Platform 120 can include a user management engine 132 and/or a model engine 142, in some embodiments. In additional or alternative embodiments, user management engine 132 can reside at server machine 130 and model engine 142 can reside at server machine 140. Platform 120 can access user management engine 132 and/or model engine 142 via network 104, in such embodiments. System 100 can additionally or alternatively include rendering engine 152. Rendering engine 152 can reside at server machine 150, in some embodiments, or at platform 120, in additional or alternative embodiments.

User management engine 132 can be configured to manage data associated with one or more users of platform 120. In some embodiments, user management engine 132 can obtain data associated with a virtual avatar associated with the user (e.g., from client device 102) and can store the obtained data at data store 110. The obtained data can include image data associated with the user, one or more avatar characteristics associated with the virtual avatar (e.g., clothing style, hair style, hair color, accessories), and so forth. Model engine 142 can be configured to generate object data associated with the virtual avatar for the user. The object data can include data used by rendering engine 152 to render the virtual avatar, in some embodiments. In some embodiments, the object data can be included in a model file that is used by rendering engine 152 to render the virtual avatar. In other or similar embodiments, modeling engine 142 may obtain a model file (e.g., from user management engine 132, from another engine or component of system 100, etc.) and can update or otherwise modify the model file prior to rendering of the 3D object, as described herein.

Object data associated with the virtual avatar (or any other type of 3D object) can include an indication of a bone structure for the virtual avatar, and/or an indication of a mesh (e.g., a polygon mesh) for the virtual avatar, and/or an indication of one or more blend shapes (also referred to as morph targets) for the avatar. The bone structure can include one or more bones that are each indicated by a bone index. The mesh can include one or more poly gons made up of vertices, edges, and faces. Each blend shape can indicate a distinct representation of at least a portion of the 3D object. For example, object data can include blend shapes for one or more faces for the virtual avatar, including a frowning face, a smiling face, and so forth. In some embodiments, the object data can additionally or alternatively include an indication of a motion vector for each vertex of at least a portion of the mesh. The motion vector can indicate a degree and/or a direction of a motion of a respective vertex in accordance with an animation of the 3D object. In an illustrative example, a motion vector can include at least three values each indicating a degree of movement of the vertex according to a respective axis of motion (e.g., an x-axis, a y-axis, a z-axis, etc.). A positive value can indicate movement in a positive direction along the axis, while a negative value can indicate movement in a negative direction along the axis. In some embodiments, the object data for a 3D object can be provided by a client device 102 associated with an artist or developer of the 3D object. In other or similar embodiments, the object data can be determined or otherwise generated by model engine 142 (e.g., based on a model template provided by an artist or developer of the 3D object and/or a developer of platform 120).

Rendering engine 152 can be configured to render a 3D object (e.g., a virtual object). In some embodiments, rendering engine 152 can render the 3D object based on a model file obtained from model engine 142. As indicated above, the model file can indicate vertices of a mesh of the 3D object and, for each vertex of the mesh, a motion vector according to each animation associated with the 3D object. Rendering engine 152 can render an animation of the 3D object by executing the model file, in some embodiments. Rendering engine 152 can be a part of platform 120, in some embodiments. In such embodiments, platform 120 can obtain the rendered 3D object (referred to a rendered object 112 herein) from rendering engine 152 at platform 120. Platform 120 can provide the rendered object 112 to a user associated with client device 102 via a UI of the application at client device 102, as described above. In other or similar embodiments, rendering engine 152 can be separate from platform 120 and may reside at server machine 150, which is accessible by platform 120 (e.g., via network 104). In such embodiments, platform 120 may provide instructions (e.g., as included in a model file) for rendering a 3D object to rendering engine 152 via network 104. Rendering engine 152 can provide the rendered object 112 to platform 120 via network 104 and platform 120 can provide the rendered object 112 to a client device 102, as described above. In other or similar embodiments, rendering engine 152 can provide the rendered object 112 directly to client device 102 (e.g., without providing the rendered object 112 to platform 120). In yet other or similar embodiments, one or more of client devices 102 can include rendering engine 152 (or at least a portion of rendering engine 152). In such embodiments, the rendering engine 152 can render 3D objects at a client device 102 and the client device 102 can provide the rendering of the 3D object to a user associated with the client device 102, as described above.

In some embodiments, platform 120 can provide one or more client devices 102 with access to a virtual space (e.g., via network 104). A virtual space refers to a simulated space or environment with which users can interact via an interface. A virtual space may also be referred to as a virtual reality or a virtual environment. Examples of virtual spaces can include, but are not limited to, a virtual meeting space, a virtual party space, a virtual concert space, a virtual sporting event space, and so forth. In some embodiments, one or more 3D objects (e.g., a virtual avatar) associated with client devices 102 accessing the virtual space can be included in the virtual space. The 3D object can interact with (e.g., view, engage with, talk to, etc.) other 3D objects in the virtual space, in some embodiments. In some embodiments, a user associated with a client device 102 can engage with one or more control elements to control an animation of the 3D object in the virtual space. A control element can include a UI element of a UI of the client device 102, an element of a peripheral device (e.g., a keyboard, a mouse, a touch screen, a virtual reality headset, one or more control components connected to a virtual reality headset, etc.) of or otherwise connected to client device 102, and so forth.

In an illustrative example, a first client device (e.g., client device 102A) and a second client device (e.g., client device 102B) can access a virtual space provided by platform 120 (e.g., via network 104). A first virtual avatar associated with client device 102A and a second virtual avatar associated with client device 102B can be included in the virtual space. A user associated with client device 102A can engage with one or more control elements to cause the first virtual avatar to walk up to the second virtual avatar in the virtual space. Another user associated with client device 102B can provide audio to client device 102B (e.g., by talking into a microphone of or connected to client device 102B) greeting the first virtual avatar. Client device 102B can transmit a request to platform 120 to update the rendering of the second virtual avatar in accordance with the audio provided by the user associated with client device 102B. Such request is referred to as an update request herein. The request can include an indication of one or more control elements that the user engaged with, in some embodiments. In other or similar embodiments, the request can include an indication of a motion or change in animation associated with the control elements that the user engaged with. In some embodiments, client device 102B can transmit the audio provided by the user with the update request and/or in a separate message to platform 120. In response to receiving the audio, platform 120 may generate one or more instructions to cause a rendering engine 152 (e.g., at server machine 150 and/or a client device 102A) to update a rendering of at least a portion second virtual avatar (e.g., mouth elements of the second virtual avatar) to move in accordance with the audio provided by the user of the second client device. Platform 120 may determine whether to generate and/or transmit the instructions to client device 102A in accordance with embodiments described herein. In response to determining to generate and/or transmit the instructions to client device 102A, platform 120 can transmit the instructions to rendering engine 152 to cause rendering engine 152 to update the rendering of the second virtual avatar. Platform 120 can additionally transmit data associated with the audio provided by the user associated with client device 102B to client device 102. Rendering engine 152 can provide the updated rendering of the second virtual avatar to a user of client device 102A (e.g., via the UI of client device 102A) with the audio (e.g., via a speaker of or connected to client device 102A).

As indicated above, a virtual space can include multiple 3D objects each associated with a client device 102 accessing the virtual space (e.g., via network 104). In some embodiments, platform 120 can receive multiple update requests from one or more client devices 102 to update renderings of 3D objects associated with the one or more client devices. One or more components of platform 120 (e.g., model engine 142) can determine a priority score associated with the update of each update request and can add each update request to an update queue associated with each client device 102 based on the determined priority score for the update, in some embodiments. In other or similar embodiments, platform 120 can determine whether the update priority score determined for an updatefalls below a threshold priority score and, if so, can determine not to add the update to an update queue for a client device 102. In some embodiments, platform 120 can generate and transmit instructions to client devices 102 based on an ordering of updates in the update queue. Further details regarding determining the update priority scores for updates to rendering of 3D objects and generating and/or transmitting instructions for updating the rendering of the 3D objects based on an ordering of updates in a priority queue for a client device 102 are provided herein.

In some implementations, platform 120 and/or server machines 130-150 may operate on one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. In some implementations, the functions of platform 120 and/or server machines 130-150 may be provided by a more than one machine. For example, in some implementations, the functions of user management engine 132, model engine 142, and/or rendering engine 152 may be provided by two or more separate server machines. Platform 120, and/or server machines 130-150 may also include a website (e.g., a webpage) or application back-end software that may be used to enable a user to access media items, as described herein.

In general, functions described in implementations as being performed by platform 120 can also be performed on the client devices 102 in other implementations, if appropriate. In addition, the functionality attributed to a particular component can be performed by different or multiple components operating together. Platform 120 can also be accessed as a service provided to other systems or devices through appropriate application programming interfaces, and thus is not limited to use in websites.

It should be noted that although some embodiments of the present disclosure are directed to a content sharing platform, embodiments of this disclosure can be applied to other types of platforms. For example, embodiments of the present disclosure can be applied to a content archive platform, a content storage platform, etc.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of the platform 120.

In situations in which the systems discussed here collect personal information about users, or can make use of personal information, the users can be provided with an opportunity to control whether platform 120 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the platform 120.

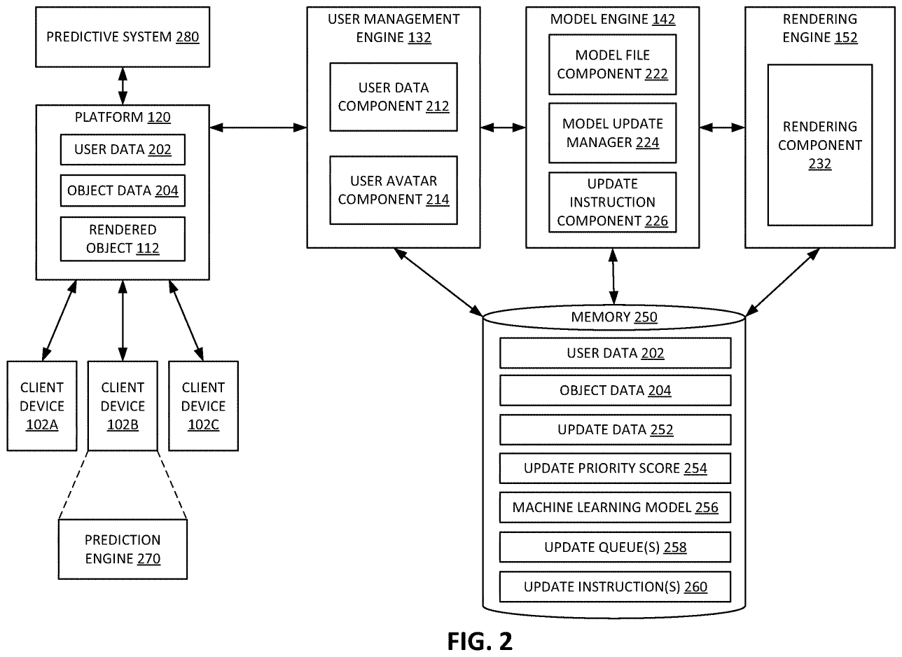

FIG. 2 illustrates an example user management engine 132, and example model engine 142, and an example rendering engine 152, in accordance with some aspects of the present disclosure. In some embodiments, user management engine 132, model engine 142, and/or rendering engine 152 can reside at or can otherwise be connected to platform 120 (e.g., via network 104). In one or more embodiments, each client device 102 can include a rendering engine 152 (or at least a portion of rendering engine 152), as described above. User management engine 132, model engine 142, and/or rendering engine 152 can be connected to memory 250, in some embodiments. Memory 250 can correspond to one or more portions of data store 110, in some embodiments. In additional or alternative embodiments, memory 250 can correspond to any memory of, connected to, or accessible by a component of system 100.

As described above, an 3D object rendered by rendering engine 152 can, in some embodiments, include a virtual avatar associated with a user of platform 120. The virtual avatar can be rendered to include one or more characteristics, as provided by the user of platform 120. The one or more characteristics can be included with or otherwise indicated by user data 202, in some embodiments. User data 202 can include data associated with a user that is provided by or otherwise received by a client device 102 associated with the user. In some embodiments, the virtual avatar can be rendered to include one or more characteristics that are the same or similar to characteristics of the user (e.g., hair color, eye color, etc.). In such embodiments, the user data 202 can include an indication of one or more characteristics of the user, as provided via client device 102. The indication of the one or more characteristics of the user can include image data for an image depicting the user, or other data that indicates the characteristics of the user, in some embodiments. In other or similar embodiments, the virtual avatar can be rendered as a character or object based on characteristics provided by the user. In such embodiments, user data 202 can include an indication of the characteristics of the character or object, as provided via client device 102.

As illustrated in FIG. 2, user management engine 132 can include user data component 212 and user avatar component 214. User data component 212 of user management engine 132 can obtain the user data 202 from platform 120 and, in some embodiments, can store the user data 202 at memory 250. In some embodiments, user data component 212 can store a mapping between the obtained user data 202 and an identifier associated with the user and/or the client device 102 associated with the user at memory 250.

In some embodiments, an artist or developer of a 3D object, such as the virtual avatar, can provide object data 204 associated with the 3D object to platform 120 (e.g., via a client device associated with the artist or developer). The object data 204 can include rendering data for default characteristics for the 3D object, as defined by the artist or the developer. For example, the object data 204 can include an indication of a bone structure and a mesh (e. g, a polygon mesh) for the 3D object, an indication of an assignment of one or more bones of the bone structure to a vertex of the mesh, and/or an indication of one or more default characteristics (e.g., indicated by default texturing coordinates, color data, etc.) for rendering the 3D object. In some embodiments, platform 120 can store the object data 204 at memory 250. User avatar component 214 of user management engine 132 can update object data 204 to include a mapping between one or more characteristics of the virtual avatar associated with the user of platform 120 to corresponding data of object data 204. For example, user avatar component 214 can update object data 204 to include a mapping between one or more tex turing coordinates and/or color data associated with a portion of the virtual avatar including the avatar's eyes and an eye color of the user, as indicated by user data component 212.

It should be noted that in other or similar embodiments, object data 204 and/or characteristics of a virtual avatar can be provided by another system other than platform 120. For example, a computing system other than platform 120 can provide a model file (not shown) for rendering the virtual avatar via rendering engine 152. The model file can include object data 204 and/or characteristics of the virtual avatar, in some embodiments. In other or similar embodiments, a model file component 222 of model engine 142 can generate or update the model file based on the user data 202 and/or the object data 204 obtained from platform 120.

As indicated above, platform 120 can provide one or more client devices 102 with access to a virtual space (e.g., a virtual meeting space, a virtual party space, a virtual concert space, a virtual sporting event space, etc.). The virtual spacecan include, in some embodiments, a rendering of a 3D object associated with a client device accessing the virtual space, in some embodiments. In an illustrative example, platform 120 can provide client device 102A, client device 102B, and client device 102C with access to a virtual space. The virtual space can include a first virtual avatar associated with client device 102A, a second virtual avatar associated with client device 102B, and a third virtual avatar associated with client device 102C, in accordance with previously described embodiments. Users of a client device 102 accessing the virtual space can interact with (or otherwise interface with) users of other client devices 102 accessing the virtual space via the corresponding 3D objects in the virtual space, as described above.

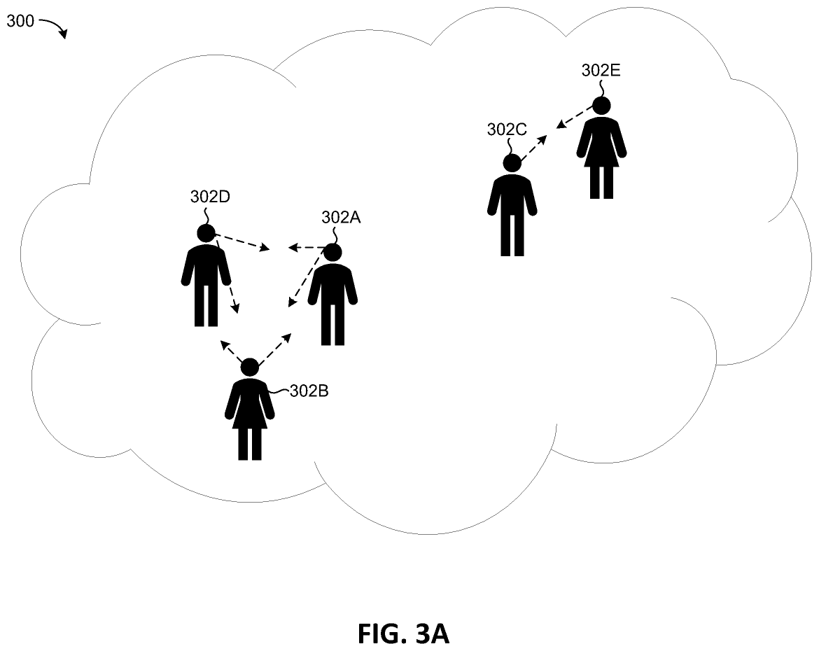

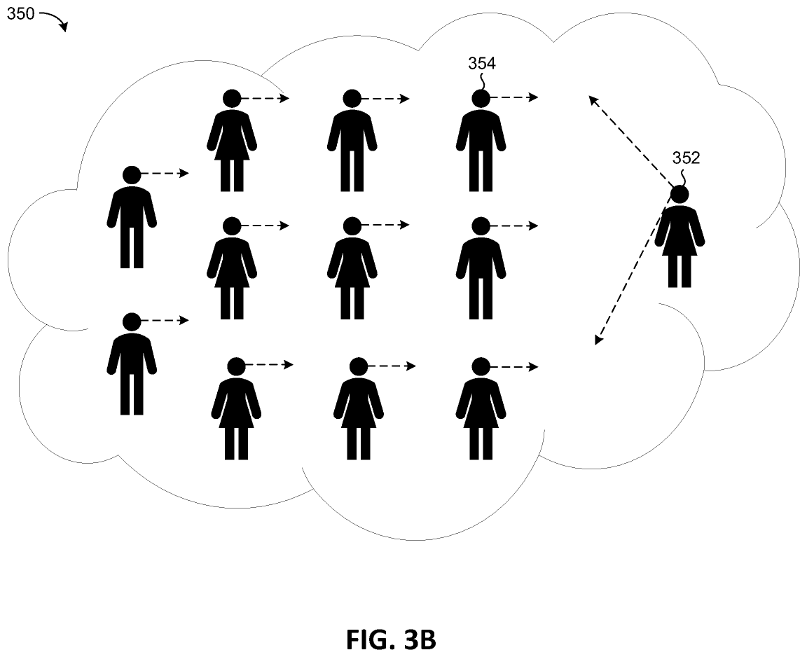

FIGS. 3A-3B illustrate example virtual spaces (e.g., virtual space 300, virtual space 350) including 3D objects, in accordance with some aspects of the present disclosure. As illustrated in FIG. 3A, virtual space 300 can include renderings of one or more virtual avatars 302. Each virtual avatar 302 can be associated with a respective client device 102 accessing the virtual space 300 (e.g., via network 104). In accordance with the previous illustrative example, virtual avatar 302A can be the first virtual avatar associated with client device 102A, virtual avatar 302B can be the second virtual avatar associated with client device 102B, and virtual avatar 302C can be the third virtual avatar associated with client device 102C. Virtual space 300 can include additional virtual avatars (e.g., virtual avatar 302D, virtual avatar 302E, etc.) associated with other client devices 102 accessing virtual space 300. It should be noted that although FIG. 3A depicts five virtual avatars 302 in virtual space 300, virtual space 300 can include any number of virtual avatars 302, in accordance with embodiments of the present disclosure.

In some embodiments, one or more virtual avatars 302 in virtual space 300 may be within or outside of a vantage point of other virtual avatars 302 in the virtual space 300. A vantage point of a virtual avatar 302 refers to an area within the virtual space 300 in which a user associated with a virtual avatar 302 can detect or notice details of one or more other virtual avatars 302 and/or one or more other 3D objects (other than virtual avatars) in the virtual space 300. Virtual avatars 302 and/or other 3D objects that are within the vantage point of a respective virtual avatar 302 may be visible and/or accessible to the respective virtual avatar 302, while virtual avatars 302 and/or other 3D objects that are outside of the vantage point may not be visible and/or accessible to the respective virtual avatar 302. Virtual avatars 302 and/or other 3D objects that are outside of the vantage point of the respective virtual avatar 302 may be presentin the virtual environment, but may not be within a field of view of the respective virtual avatar 302.

In some embodiments, a user associated with a virtual avatar 302 in virtual space 300 may not be able to detect or notice details of a virtual avatar 302 that is outside of the vantage point of the associated avatar 302 within the virtual space 300. In an illustrative example, virtual avatar 302A may be facing virtual avatar 302B in the virtual space. Virtual avatar 302A may also be within a distance from virtual avatar 302B such that virtual avatar 302B is within the vantage point of virtual avatar 302A. Accordingly, a user associated with virtual avatar 302A may be able to detect or notice details of virtual avatar 302B thatis rendered for presentation via a UI of client device 102A. In an additional or alternative illustrative example, virtual avatar 302A may be facing an opposite direction of virtual avatar 302C. Virtual avatar 302A may additionally or alternatively may be outside of a vantage point of virtual avatar 302A. Accordingly, a user associated with virtual avatar 302A may not be able to detect or notice details of virtual avatar 302C that is rendered for presentation via the UI of client device 102A. In yet an additional or alternative illustrative example, virtual avatar 302B may be facing a direction of a portion of virtual avatar 302C (e.g., a back portion of virtual avatar 302C). However, virtual avatar 302C may be outside of a vantage point of virtual avatar 302C and/or an outside of a vantage point of portions of interest (e.g., a front portion) of virtual avatar 302C. Accordingly, a user associated with virtual avatar 302B may not be able to detect or notice details of the portions of interest (e.g., the front portion) of virtual avatar 302C that is rendered for presentation via the UI of client device 102B.

FIG. 3B illustrates another example virtual space 350, in accordance with embodiments of the present disclosure. In an illustrative example, virtual space 350 can correspond to a virtual concert space or a virtual event space. Such virtual space 350 can include one or more performer virtual avatars 352 and/or one or more audience virtual avatars 354. In some embodiments, a performer virtual avatar 352 can provide a performance for the one or more audience virtual avatars 354. The performance can mimic movements, expressions, and/or a voice of a performer based on a live performance of the performer and/or a pre-recorded performance of the performer. In an example of a virtual concert, the performer virtual avatar 352 may be animated to perform using instruments, dance, sing, or otherwise interact with the audience virtual avatars 354. In an example of a virtual event, the performer virtual avatar 352 may give a speech or presentation, provide a demonstration, and so forth for the audience virtual avatars 354.

As illustrated in FIG. 3B, a performer virtual avatar 352 may face the audience virtual avatars 354 in the virtual space. One or more of the audience virtual avatars 354 may be within the vantage point of the performer virtual avatar 352 while other audience virtual avatars 354 may not be within the vantage point of the performer virtual avatar 352. The performer virtual avatar 352 may be within the vantage point of each of the audience virtual avatars 354, in some embodiments. In additional or alternative embodiments, one or more audience virtual avatars 354 may be in the vantage point of a respective audience virtual avatar 354 (e.g., audience virtual avatars 354 located between the respective audience virtual avatar 354 and the performer virtual avatar 352), while other audience virtual avatars 354 may not be in the vantage point of the respective audience virtual avatar 354 (e.g., audience virtual avatars 354 located beside and/or behind the respective audience virtual avatar 324). In such embodiments, a user associated with the respective virtual avatar 354 may not be able to detect or notice details of a rendering of the audience virtual avatar(s) 354 that are outside of the vantage point of the respective audience virtual avatar 354.

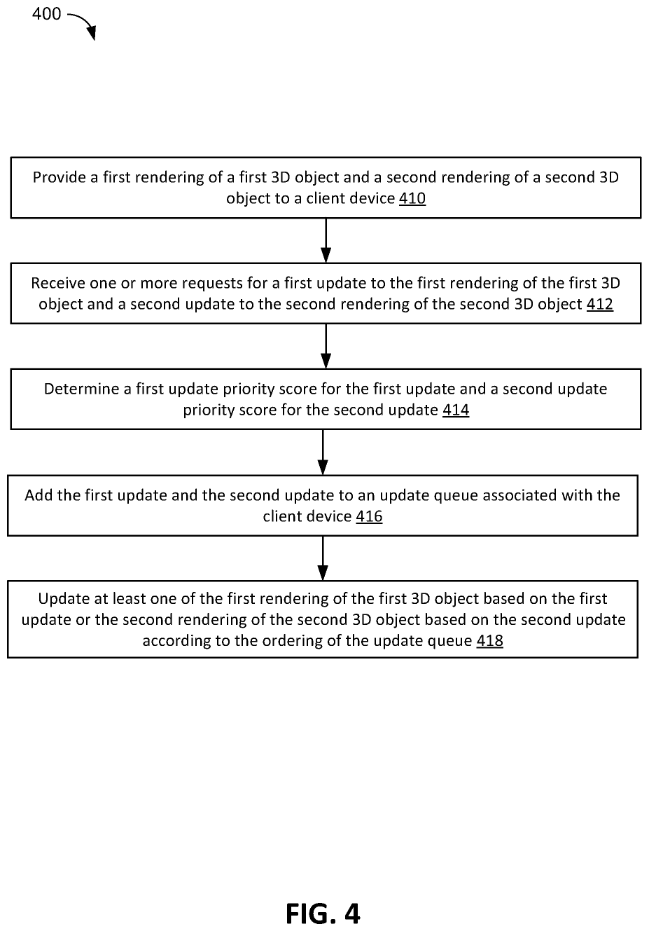

Referring back to FIG. 2, a user associated with a 3D object can control a motion of the 3D object in the virtual space, in some embodiments. As describe above, a user can interact with one or more control elements of a client device 102 to cause the 3D object to move within the virtual space. In an illustrative example, a user can interact with one or more control elements to move one or more body parts (e.g., arms, legs, etc.) of a virtual avatar and/or change or modify a facial expression of the virtual avatar. In response to a user interacting with one or more control elements of a client device 102, the client device 102 can transmit a request to platform 120 to update the rendering of the 3D object associated with the user in accordance with the motion. Such request is referred to herein as an update request. In response to receiving an update request, model engine 142 (or another component of Internet accessible to platform 120) can determine whether to update the rendering of the 3D object on one or more other client devices 102 accessing the virtual space, as described herein. In an illustrative example, client device 102A can transmit an update request to platform 120. In response to model engine 142 determining to update the rendering of the 3D object associated with client device 102A in accordance with the update request, platform 120 can transmit instructions to cause the rendering of the 3D object to be updated for client devices 102B and/or client device 102C. One or more components of model engine 142 can determine whether to update the rendering of the 3D object based on an update priority score associated with the update of the update request. Details regarding determining an update priority score are provided below with respect to FIGS. 4-9.

FIG. 4 illustrates a flow diagram for an example method 400 for updating renderings of three-dimensional (3D) objects at one or more client devices accessing a virtual space, in accordance with some aspects of the present disclosure. Method 400 may be performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1 and/or one or more components of FIG. 2. In some embodiments, one or more operations of method 400 may be performed by one or more components of model engine 142. For example, one or more operations of method 400 can be performed by model update manager 224 and/or update instruction component 226 of model engine 142.

At block 410, processing logic provides a first rendering of a first 3D object and a second rendering of a second 3D object to a client device. For purposes of example and illustration only, the first 3D object may be referred to herein as the first virtual avatar associated with client device 102A and the second 3D object mat be referred to herein as the second virtual avatar associated with client device 102B. The client device, as included in block 410, may be referred to as client device 102C, in some embodiments. It should be noted that the first 3D object and/or the second 3D object can include any 3D object in a virtual space (e.g., virtual space 300, virtual space 350, etc.) and/or can include one or more components of a 3D object in the virtual space, in accordance with embodiments of the present disclosure. For example, the first 3D object can correspond to a first component of a virtual avatar and the second 3D object can correspond to a second component of the virtual avatar. It should also be noted that the first 3D object and/or the second 3D object can be associated with any client device accessing the virtual space. For example, the first 3D object and/or the second 3D object can both be associated with the same client device 102 and/or any other client device 102, as described herein.

In some embodiments, each of client devices 102A-102C can transmit a request to platform 120 to access a virtual space. In response to receiving a request from at least one of client devices 102A-102C, model file component 222 of model engine 142 can obtain a model file associated with a 3D object (e.g., a virtual avatar) associated with a respective client device 102A-102C. In response to obtaining the model file, model engine 142 can provide the model file (or at least a portion of the model file) to rendering engine 152 (e.g., residing at platform 120, at server machine 150, and/or at a respective client device 102A-102C). Rendering component 232 of rendering engine 152 can render the 3D object associated with the 3D object and can provide the rendered object 112 to each of client devices 102A-102C. In an illustrative example, rendering engine 152 can provide a rendering of a first virtual avatar (e.g., virtual avatar 302A) associated with client device 102A to one or more of client device 102A, client device 102B or client device 102C. Rendering engine 152 can additionally or alternatively provide a rendering of a second virtual avatar (e.g., virtual avatar 302B) associated with client device 102B and/or a rendering of a third virtual avatar (e.g., virtual avatar 302C) associated with client device 102C to one or more of client device 102A, client device 102B or client device 102C.

Referring back to FIG. 4, at block 412, processing logic receives one or more requests for a first update to the first rendering of the first 3D object and a second update to a second rendering of the second 3D object. As described above, a user of a client device 102 can interact with one or more control elements of a client device 102 to cause a 3D object associated with the client device 102 to move and/or change an expression. In response to detecting the user interaction with the one or more control elements, the client device 102 can transmit an update request to platform 120 to update the rendering of the 3D object in accordance with the motion or change in expression. In accordance with one or more previous illustrative examples, client device 102A can transmit an update request to platform 120 to update a rendering of virtual avatar 302A and client device 102B can transmit an update request to platform 120 to update a rendering of virtual avatar 302B. It should be noted that the update requests from client devices 102A can be transmitted during the same (or approximately the same) time period or during different time periods, in some embodiments. In some embodiments, platform 120 can store data associated with an update request at memory 250 as update data 252. Further details regarding update data 252 are described herein.

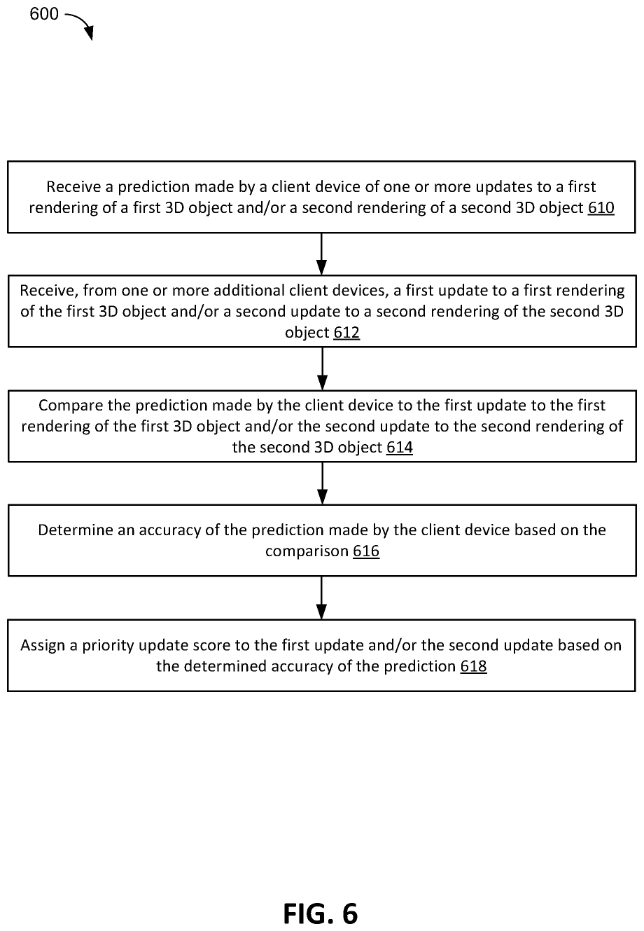

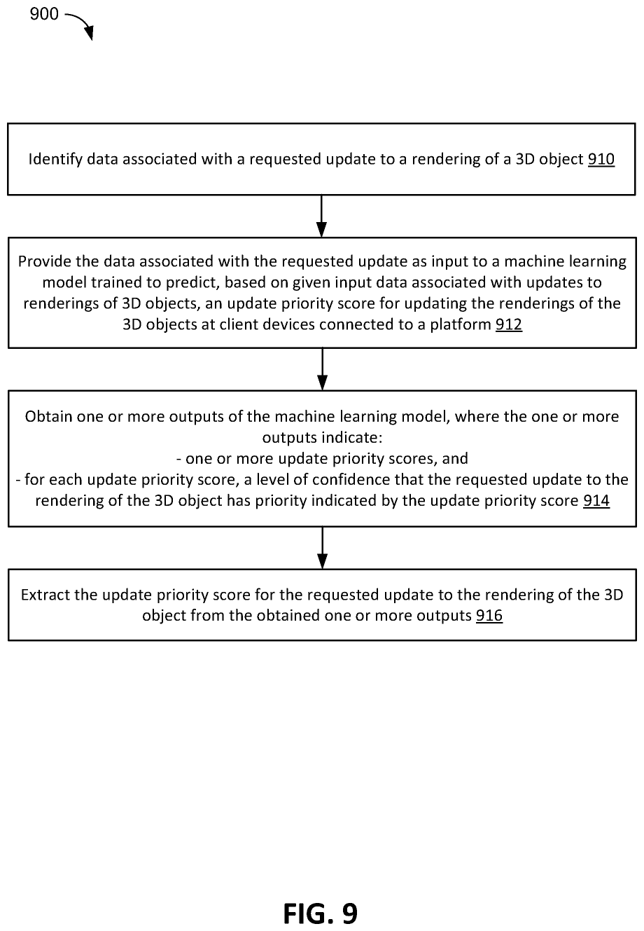

At block 414, processing logic can determine a first update priority score for the first update and a second update priority score for the second update. In some embodiments, model update manager 224 can determine one or more update priority scores 254 for each update of update requests received by platform 120. Each of the one or more update priority scores 254 can indicate an update priority for updating the rendering of the 3D object for one or more client devices 102 accessing the virtual space. In accordance with one or more previous illustrative examples, model update manager 224 can determine an update priority score 254 for updating the rendering of virtual avatar 302A for client device 102B and another update priority score 254 for updating the rendering of virtual avatar 302A for client device 102C. Model update manager 224 can additionally or alternatively determine an update priority score 254 for updating the rendering of virtual avatar 302B for client device 102A and another update priority score 254 for updating the rendering of virtual avatar 302B for client device 102C. In some embodiments, model update manager 224 can determine the update priority score 254 for updating a rendering of a 3D object for a particular client device 102 based on one or more update factors, which can include at least one of: a level of visibility of the 3D object from a vantage point of at least one or more other 3D objects (e.g., including a 3D object associated with the particular client device 102), a time period since the rendering of the 3D object has been update for the particular client device 102), a number of 3D objects of the virtual space having vantage points that include the 3D object, a degree of motion associated with the update to the rendering of the 3D object in the virtual space, an audio level of audio associated with the 3D object, a distance between the 3D object and other 3D objects in the virtual space, a distance between the 3D object and a 3D object of interest by one or more other 3D objects in the virtual space, an accuracy of a prediction by the particular client device of a motion of the 3D object, and/or a speed or level of bandwidth of a network connection between the particular client device and platform 120. Details regarding determining the update priority score associated with an update to a 3D object for a particular client device are described with respect to FIGS. 6 and 9 below.

In some embodiments, update priority score 254 is referred to as having a value between 0.0 and 1.0, 0.0 indicating that the update at the particular client device 102 has a low priority and 1.0 indicating that the update at the particular client device 102 has a high priority. A high priority indicates that an update at a particular client device 102 is likely to be detected or noticed by a user associated with the particular client device 102. A low priority indicates that an update at a particular client device 102 is not likely to be detected or noticed by a user associated with the particular client device 102. It should be noted that update priority scores 254 can have other values or ranges of values, in accordance with embodiments of the present disclosure.

In some embodiments, one or more client devices 102 accessing a virtual space can include or be connected to a prediction engine 270 that is configured to predict a motion of one or more 3D objects in the virtual space. Prediction engine 270 can include or otherwise access a machine learning model that is trained to predict a motion of 3D objects in the virtual space. Such machine learning model is referred to as a 3D object prediction model. In some embodiments, a client device 102 can receive instructions to update a rendering of a 3D object associated with another client device 102, in accordance with embodiments of the present disclosure. For example, client device 102B can receive instructions (e.g., from update instruction component 226) to update a rendering of virtual avatar 302A and/or virtual avatar 302C, associated with client device 102A and/or client device 102C, respectively. Prediction engine 270 can feed data associated with the instructions for updates to 3D objects associated with client device 102B as input to the 3D object prediction model and can obtain one or more outputs of the 3D object prediction model. In some embodiments, prediction engine 270 can also feed data associated with instructions for updates to other 3D objects in the virtual space as additional input to the 3D object prediction model. The one or more outputs can indicate a prediction of a future motion for one or more of virtual avatar 302A and/or virtual avatar 302C. In some embodiments, prediction engine 270 and/or another component of client device 102B can generate or otherwise obtain instructions for updating the rendering of a 3D object according to a predicted motion and can provide the instructions to rendering component 232, in some embodiments. Rendering component 232 can execute the instructions to generate rendered object 112, as described herein.

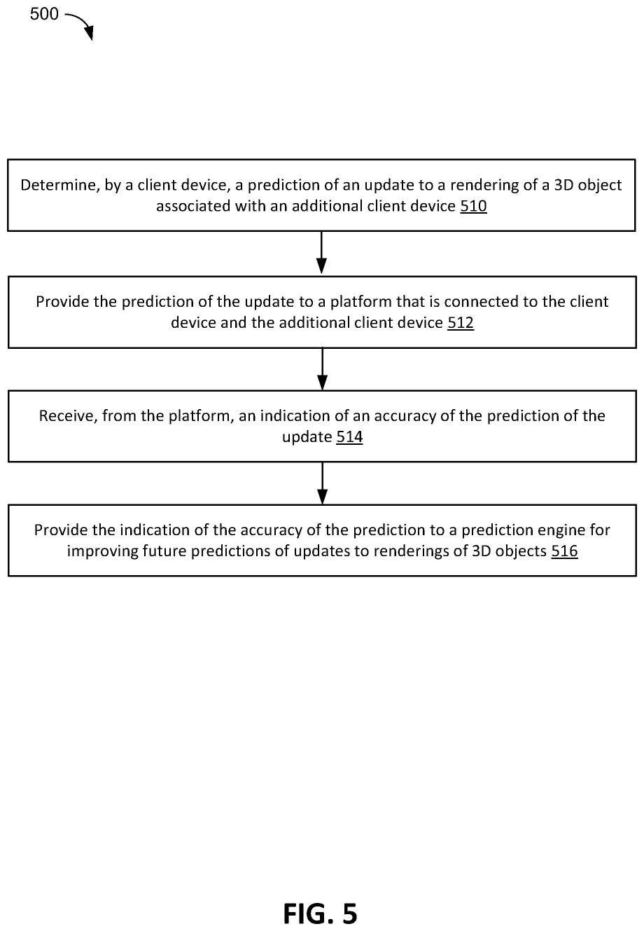

In some embodiments, client device 102B can transmit an indication of the prediction by prediction engine 270 to platform 120. Model update manager 224 can compare the prediction for the update to a rendering of a 3D object to an update of an update request received by a client device 102 associated with the 3D object and can determine an update priority score 254 for the update of the update request based on the comparison. Further details regarding obtaining the prediction by prediction engine 270 and determining an update priority score 254 based on the prediction are described with respect to FIGS. 5 and 6 below.

FIG. 5 illustrates a flow diagram for an example method 500 of improving an accuracy of predictions made by a prediction engine, in accordance with some aspects of the present disclosure. FIG. 6 illustrates a flow diagram for an example method 600 of determining an update priority score for an update to a rendering of a 3D object, in accordance with some aspects of the present disclosure. Methods 500 and 600 may be performed by processing logic that may include hardware (circuitry, dedicated logic, etc.), software (e.g., instructions run on a processing device), or a combination thereof. In one implementation, some or all the operations of method 500 may be performed by one or more components of system 100 of FIG. 1 and/or one or more components of FIG. 2. In some embodiments, one or more operations of method 500 may be performed by one or more of client devices 102. In some embodiments, one or more operations of method 600 may be performed by one or more components of model engine 142. For example, one or more operations of method 600 can be performed by model update manager 224 and/or update instruction component 226 of model engine 142.

Referring now to FIG. 5, at block 510, processing logic can determine, by a client device, a prediction of an update to a rendering of a 3D object associated with an additional client device. According to at least one previous illustrative example, the client device can correspond to client device 102B. Client device 102B can obtain a prediction of an update to virtual avatar 302A associated with client device 102A based on an output of a 3D object prediction model, as described above. Atblock 512, processing logic can provide the prediction of the update to a platform (e.g., platform 120) that is connected to the client device and the additional client device.

Referring now to FIG. 6, at block 610, processing logic receives a prediction made by a client device of one or more updates to a first rendering of a first 3D object and/or a second rendering of a second 3D object. In accordance with the previous example, model update manager 224 can receive the prediction made by predictive engine 270 of client device 102B regarding the update to virtual avatar 302A associated with client device 102A.

At block 612, processing logic receives, from one or more additional client devices, a first update to a first rendering of the first 3D object or a second update to a second rendering of the second 3D object. In some embodiments, model update manager 224 can receive an update request to update a rendering of virtual avatar 302A associated with client device 102A, in accordance with previously described embodiments. The update can be received in response to a user interaction with one or more control elements of client device 102A, as described above.

At block 614, processing logic compares the prediction made by the client device to the first update to the first rendering of the first 3D object and/or the second update to the second rendering of the second 3D object. Model update manager 224 can compare the prediction made by prediction engine 270 of client device 102B to the update of the update request for virtual avatar 302A by determining whether the motion of the prediction corresponds to the motion of the update of the update request.

At block 616, processing logic determines an accuracy of the prediction made by the client device based on the comparison. Model update manager 224 can determine that the prediction made by the prediction engine 270 of client device 102B has a high accuracy if the motion of the prediction corresponds (or substantially corresponds) to the motion of the update request from client device 102A, in some embodiments. In other or similar embodiments, model update manager 224 can determine that the prediction made by the prediction engine 270 of client device 102B has a low accuracy if the motion of the prediction does not correspond (or substantially correspond) to the motion of the update request from client device 102A. In some embodiments, the accuracy of the prediction can be represented as a binary value. For example, the accuracy of the prediction can be associated with a value of 1.0 (or approximately 1.0) if model update manager 224 determines the prediction to have a high accuracy and a value of 0.0 (or approximately 0.0) if model update manager 224 determines the prediction to have a low accuracy. In other or similar embodiments, the accuracy of the prediction can be represented as a degree or a percentage. For example, if the predicted motion of virtual avatar 302A is a “high-five” gesture directed towards another 3D object and the motion of the update of the update request is a “thumbs up” gesture directed towards the other 3D object, the accuracy of the prediction can be between approximately 50% and approximately 75%, in some embodiments.

At block 618, processing logic assigns a priority update score to the first update and/or the second update based on the determined accuracy of the prediction. In some embodiments, model update manager 224 can assign a high update priority score 254 (e.g., a score of or around 1.0) to an update in response to determining that an accuracy of the prediction by prediction engine 270 is low. In other or similar embodiments, model update manager 224 can assign a low priority score 254 (e.g., a score of or around 0.0) to an update in response to determining that an accuracy of the prediction by prediction engine 270 is high. Model update manager 224 can determine whether to generate and/or transmit instructions for the update to client device 102B and/or can add the update to update queue 258 associated with client device 102B, as described below. In some embodiments, model update manager 224 can transmit an indication of an accuracy of the prediction by prediction engine 270 to client device 102B (e.g., with the transmitted instructions and/or in a separate message to client device 102B).

Referring back to FIG. 5, atblock 514, processinglogic receives, from the platform, an indication of an accuracy of the prediction of the update to the rendering of the 3D object associated with the additional client device. In some embodiments, platform 120 can transmit a message to client device 102B including an indication of whether the predicted update to the rendering of the 3D object was accurate or not. In other or similar embodiments, platform 120 can transmit a message to client device 102B indicating a degree (e.g., a percentage) of the accuracy of the predicted update. Platform 120 can transmit the indication of the accuracy of the prediction of the update with instructions to render the update of the 3D object or in a separate message to client device 102B.

At block 516, processing logic provides the indication of the accuracy of the prediction to the prediction engine for improving future predictions of updates to renderings of 3D objects. In some embodiments, client device 102B can provide the indication of the accuracy to prediction engine 270. Prediction engine 270 can use the indicated accuracy to retrain the 3D object prediction model to make more accurate predictions to updates of renderings of 3D objects, in some embodiments.

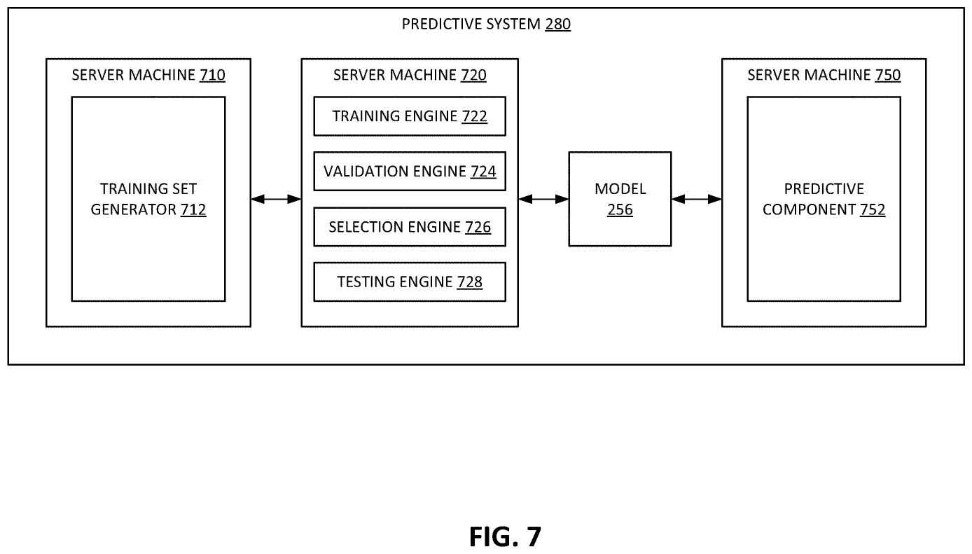

As illustrated in FIG. 2, platform 120 can include or be connected to a predictive system 280, in some embodiments. Predictive system 280 can be configured to train a machine learning model (e.g., machine learning model 256) to predict an update priority score 254 for an update to a 3D object for a particular client device 102 accessing a virtual space. Such machine learning model is referred to herein as an update priority prediction model. Predictive system 280 can also be configured to feed update data 252 and/or other data as input to the trained machine learning model 256 and obtain one or more outputs of the machine learning model 256. Predictive system 280 and/or one or more components of platform 120 can extract the update priority score 254 for the update to the 3D object for the particular client device 102 from the obtained one or more outputs. Further details regarding training the machine learning model 256 and an inference of the machine learning model 256 are described with respect to FIGS. 7-9 below.

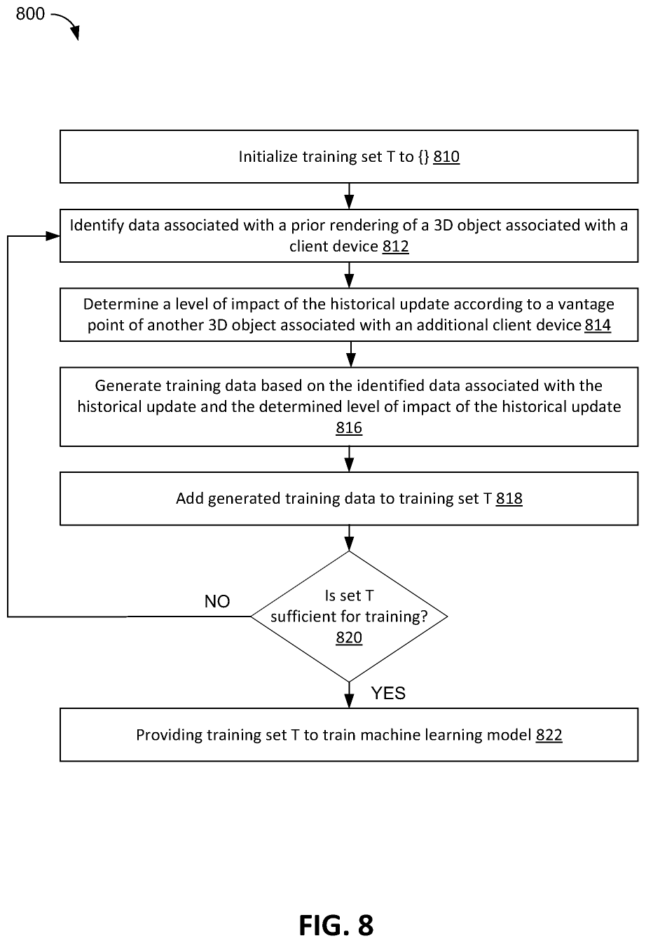

FIG. 7 illustrates an example predictive system 280, in accordance with some aspects of the present disclosure. As illustrated in FIG. 7, predictive system 280 can include a training set generator 712 (e.g., residing at server machine 710), a training engine 722, a validation engine 724, a selection 726, and/or a testing engine 728 (e.g., each residing at server machine 720), and/or a predictive component 752 (e.g., residing at server machine 750). Training set generator 712 may be capable of generating training data (e.g., a set of training inputs and a set of target outputs) to train ML model 256. Details regarding generating training data for training ML model 256 (e.g., the update priority prediction model) are described with respect to FIG. 8 below.

FIG. 8 illustrates a flow diagram for an example method 800 of training a machine learning model, in accordance with some aspects of the present disclosure. Method 800 may be performed by processing logic that may include hardware (circuitry, dedicated logic, etc.), software (e.g., instructions run on a processing device), or a combination thereof. In one implementation, some or all the operations of method 800 may be performed by one or more components of system 100 of FIG. 1 and/or one or more components of FIG. 2 or FIG. 7. In some embodiments, one or more operations of method 800 may be performed by one or more components of predictive system 280. For example, one or more operations of method 800 can be performed by training set generator 712, in some embodiments.

At block 810, processing logic initializes a training set T to null (e.g., { }). At block 812, processing logic identifies data associated with a prior rendering of a 3D object associated with the client device. In some embodiments, the identified data can be associated with a prior rendering of a virtual avatar included in a prior virtual space accessed by the client device, as described above. Theidentified data can include, in some embodiments, a prior location of the prior rendering of the virtual avatar in the prior virtual space, a motion or expression of the rendering of the virtual avatar in the prior virtual space, and so forth. In some embodiments, the prior rendering of the virtual avatar can be generated based on video data provided by a user of platform 120. In other or similar embodiments, the prior rendering can be generated based on other data (e.g., synthetic data) provided or otherwise obtained by platform 120. For example, the prior rendering can be generated based on a simulated scene of an interactive environment (e.g., a simulated driving environment, etc.).

At block 814, processing logic determines a level of impact of the historical update according to a vantage point of another 3D object associated with an additional client device. In some embodiments, the level of impact can be represented as an impact score that indicates a level of attention or detection of the 3D object by a user associated with the other 3D object associated with the additional client device. In some embodiments, the level of impact can be provided to training set generator 712 as ground truth data (e.g., obtained from a user associated with the other 3D object in the prior virtual space). In other or similar embodiments, the level of impact can be determined based on one or more factors, including a level of visibility of the 3D object from a vantage point of at least one or more other 3D objects in the prior virtual space, a number of 3D objects of the prior virtual space having vantage points that include the 3D object, a degree of motion associated with the rendering of the 3D object in the prior virtual space, an audio level of audio associated with the 3D object, a distance between the 3D object and other 3D objects in the prior virtual space, a distance between the 3D object and a 3D object of interest by one or more other 3D objects in the prior virtual space, an accuracy of a prior prediction by a client device associated with the other 3D object of a motion of the 3D object in the prior virtual space, and/or a speed or level of bandwidth of a network connection between the client device and platform 120.

At block 816, processing logic generates training data based on the identified data associated with the historical update and the determined level of impact of the historical update. In some embodiments, training set generator 712 generates a mapping between the identified data associated with the historical update and the determined level of impact of the historical update. Training set generator 712 can generate training data according to other techniques, in some embodiments.

At block 818, processing logic adds the generated training data to training set T. At block 820, processing logic determines whether set T is sufficient for training. In response to processing logic determining that set T is not sufficient for training (e.g., an amount of training data of the training set T falls below a threshold value), method 800 returns to block 812. In response to determining that set T is sufficient for training, method 800 proceeds to block 822. At block 822, processing logic provides training set T to train machine learning model 256. In some embodiments, training set generator 712 provides the training set T to training engine 722.

Referring back to FIG. 7, training engine 722 can train a machine learning model 256 using the training data (e.g., training set T) from training set generator 712. The machine learning model 256 can refer to the model artifact that is created by the training engine 722 using the training data thatincludes traininginputs and/or corresponding target outputs (correct answers for respective traininginputs). The training engine 722 can find patterns in the training data that map the training input to the target output (the answer to be predicted), and provide the machine learning model 256 that captures these patterns. The machine learning model 256 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation leaming algorithm or the like. For convenience, the remainder of this disclosure will refer to the implementation as a neural network, even though some implementations might employ an SVM or other type of learning machine instead of, or in addition to, a neural network. In one aspect, the training set is obtained by training set generator 712 hosted by server machine 710.

Validation engine 724 may be capable of validating a trained machine learning model 256 using a corresponding set of features of a validation set from training set generator 712. The validation engine 724 may determine an accuracy of each of the trained machine learning models 256 based on the corresponding sets of features of the validation set. The validation engine 724 may discard a trained machine learning model 256 that has an accuracy that does not meet a threshold accuracy. In some embodiments, the selection engine 726 may be capable of selecting a trained machine learning model 256 that has an accuracy that meets a threshold accuracy. In some embodiments, the selection engine 726 may be capable of selecting the trained machine learning model 256 that has the highest accuracy of the trained machine learning models 256.

The testing engine 186 may be capable of testing a trained machine learning model 256 using a corresponding set of features of a testing set from training set generator 712. For example, a first trained machine learningmodel 256 that was trained using a first set of features of the training set may be tested using the first set of features of the testing set. The testing engine 728 may determine a trained machine learning model 256 that has the highest accuracy of all of the trained machine learning models based on the testing sets.

Predictive component 752 of server machine 750 may be configured to feed data associated with an update to a rendering of a 3D object as input to trained model 256 and obtain one or more outputs of model 256. Predictive component 752 may extract an update priority score associated with the update for each client device 102 accessing a virtual space provided by platform 120 from the one or more outputs, in some embodiments. Predictive component 752 can provide the extracted update priority score to model update manager 224, as described herein. In other or similar embodiments, predictive component 752 may provide one or more outputs to model update manager 224 and model update manager 224 may extract the update priority score for updating the rendering of the 3D object at each client device 102 from the one or more outputs, as described herein. Further details regarding determining the update priority score(s) based on outputs of a machine learning model are described with respect to FIG. 9 below.

FIG. 9 illustrates a flow diagram for another example method 900 of determining an update priority score for an update to a rendering of a 3D object, in accordance with some aspects of the present disclosure. Method 900 may be performed by processing logic that may include hardware (circuitry, dedicated logic, etc.), software (e.g., instructions run on a processing device), or a combination thereof. In one implementation, some or all the operations of method 900 may be performed by one or more components of system 100 of FIG. 1 and/or one or more components of FIG. 2. In some embodiments, one or more operations of method 900 may be performed by one or more components of model engine 142. For example, one or more operations of method 900 can be performed by model update manager 224 and/or update instruction component 226 of model engine 142. In additional or alternative embodiments, one or more operations of method 900 can be performed by predictive component 752 of predictive system 280, as described above.

At block 910, processing logic identifies data associated with a requested update to a rendering of a 3D object. In some embodiments, the data can correspond to an update request from client device 102A and/or client device 102B, as described above. The data can correspond to update data 252, in some embodiments. In some embodiments, the data can include an indication of one or more factors of the update, including but not limited to: a level of visibility of the 3D object from a vantage point of at least one or more other 3D objects (e.g., including a 3D object associated with the particular client device 102), a time period since the rendering of the 3D object has been update for the particular client device 102), a number of 3D objects of the virtual space having vantage points that include the 3D object, a degree of motion associated with the update to the rendering of the 3D object in the virtual space, an audio level of audio associated with the 3D object, a distance between the 3D object and other 3D objects in the virtual space, a distance between the 3D object and a 3D object of interest by one or more other 3D objects in the virtual space, an accuracy of a prediction by the particular client device of a motion of the 3D object, and/or a speed or level of bandwidth of a network connection between the particular client device and platform 120.

At block 912, processing logic provides the data associated with the requested update as input to a machine learning model. In some embodiments, the machine learning model can be model 256, as described above. Machine learning model 256 can be configured to predict, based on given input data associated with updates to renderings of 3D objects, an update priority score for updating the renderings of the 3D objects at client devices connected to a platform.

At block 914, processing logic obtains one or more outputs of the machine learning model. The one or more outputs can indicate one or more update priority scores and, for each update priority score, a level of confidence that the requested update to the rendering of the 3D object has a priority indicated by the update priority score. In some embodiments, the one or more outputs can indicate update priority score(s) for each client device 102 accessing the virtual space. In other or similar embodiments, the one or more outputs can indicate an update priority score for a particular client device 102 accessing the virtual space.

At block 916, processinglogic can extract the update priority score for the requested update to the rendering of the 3D object from the obtained one or more outputs. Processing logic can, in some embodiments, identify a priority score from the one or more update priority scores, having a level of confidence that satisfies one or more confidence criteria (e.g., exceeds a level of confidence threshold). Processing logic can extract the identified priority score from the one or more outputs. The extracted priority score can be stored at memory 250 as update priority score 254, as described above.

It should be noted that model update manager 224 and/or any other component of system 100 can determine an update priority score 254 for an update to a rendering of a 3D object for a particular client device 102 according to any other techniques not described above. For example, model update manager 224 can determine the update priority score 254 based on one or more rules (e.g., defined by a developer or operator of platform 120, etc.). The rules can indicate one or more conditions that are to be satisfied in order to assign an update a particular update priority score. For example, the rules can provide that if a 3D object associated with a particular client device 102 is within a first threshold distance of another 3D object of an update request (e.g., corresponding to a first level of visibility by the 3D object), that a first update priority score is to be assigned to the update for the particular client device 102, if the 3D object is outside of the first threshold distance but within a second threshold distance of the other 3D object (e.g., corresponding to a second level of visibility by the 3D object), that a second update priority score is to be assigned to the update for the particular client device 102, and so forth. The same or similar rules can be applied to other update factors relating to the update of an update request, as described herein.

Referring back to FIG. 2, model update manager 224 can determine whether to update the rendering of the 3D object at a particular client device 102 accessing a virtual space based on the update priority score 254 for the update, determined in accordance with embodiments described above. In some embodiments, model update manager 224 can determine whether the update priority score 254 determined for an update for a particular client device 102 satisfies one or more update priority score conditions. An update priority score 254 can satisfy an update priority score condition if the update priority score 254 exceeds a threshold update priority score, in some embodiments. In response to determining that the update priority score 254 satisfies the one or more update priority score conditions, model update manager 224 can determine that the update is to be rendered for the particular client device 102, in accordance with embodiments described herein. In some embodiments, the one or more update priority score conditions can be provided to platform 120 by a developer and/or an operator of platform 120. In other or similar embodiments, the one or more update priority score conditions can be determined by one or more components of platform 120 based on historical or experimental data collected over time.

Referring back to FIG. 4, at block 416, processing logic can add the first update and the second update to an update queue associated with the client device. In some embodiments, model update manager 224 can add an update to one or more update queues 258 each associated with a respective client device 102 accessing the virtual space. Platform 120 can maintain an update queue 258 for each client device 102 that accesses the virtual space, in some embodiments. Each update queue 258 can include one or more updates to renderings of 3D objects in the virtual space. Update instruction component 226 can generate and/or transmit instructions 260 for rendering updates of the update queue 258 for a particular client device 102 based on an ordering of the updates in the update queue 258. For example, update instruction component 226 can generate and/or transmit instructions 260 for updates at or close to a head of the update queue 258 prior to generating and/or transmitting instructions for updates at or close to a tail of the update queue 258. In some embodiments, updates for a particular client device 102 having update priority scores 254 for a particular that satisfy the one or more update priority score conditions can be added to the update queue 258 for the particular client device 102 based on the update priority score 254 for the update. In an illustrative example, an update priority score 254 determined for an update to a 3D object at a particular client device 102 can have a value between 0.0 and 1.0. Model update manager 224 can add an update having an update priority score 254 at or close to 1.0 towards a head of the update queue 258 for the particular client device 102 and an update having a priority score 254 at or close to 0.0 towards a tail of the update queue 258, in some embodiments. In additional or alternative embodiments, model update manager 224 can add updates to the update queue 258 such that the update priority scores 254 for the updates decrease from the head of the update queue 258 to the tail of the update queue 258. For example, a first update at the head of the update queue 258 may have an update priority score 254 of 0.98, a second update adjacent to the first update in the queue 258 can have an update priority score 254 of 0.96, and so forth.

At block 418, processing logic can update at least one of the first rendering of the first 3D object based on the first update or the second rendering of the second 3D object based on the second update according to the ordering of the update queue. As indicated above, update instruction component 226 can generate and/or transmit instructions 260 for updating a rendering of a 3D object at a particular client device 102 based on an ordering of updates in the update queue 258 for the particular client device 102. In an illustrative example, the update to virtual avatar 302A at client device 102B can have an update priority score 254 of 0.96 and the update to virtual avatar 302C at client device 102B can have an update priority score of 0.32. Accordingly, model update manager 224 can add the updates to virtual avatars 302A and 302C to the update queue 258 associated with client device 102B in accordance with the value of the update priority scores for each virtual avatar. In accordance with the illustrative example, update instruction component 226 can generate and/or transmit the instructions 260 to update the rendering of virtual avatar 302A prior to updating the rendering of virtual avatar 302C at client device 102B.

Update instruction component 226 can transmit instructions 260 for updating renderings of 3D objects at a particular client device 102 to rendering component 232. Rendering component 232 can execute the instructions 260 to update the rendering of the 3D objects and can provide the rendered object 112 to the particular client device 102, in accordance with previously described embodiments.

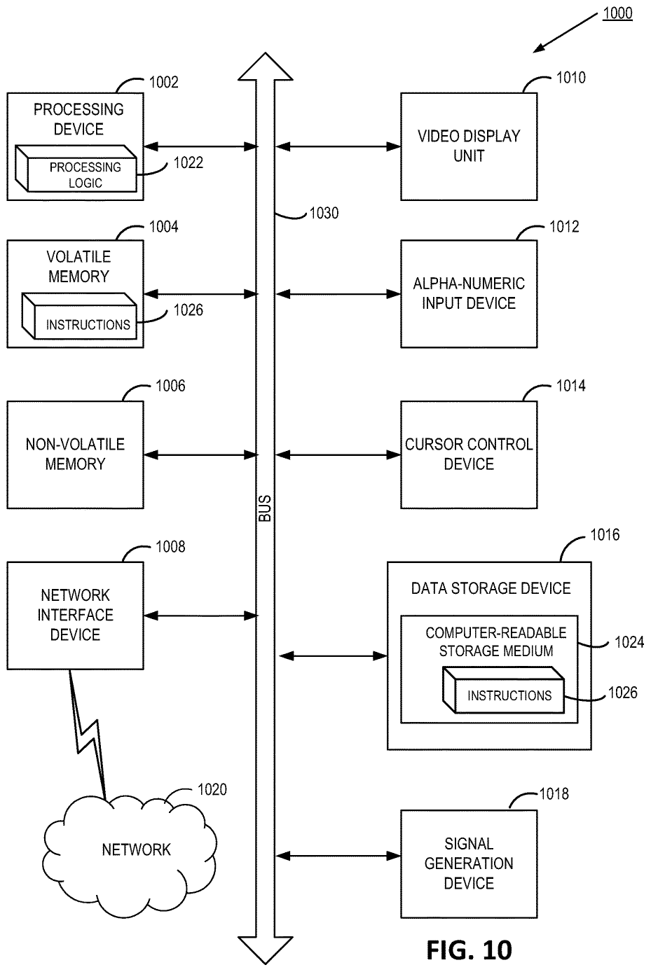

FIG. 10 is a block diagram illustrating an exemplary computer system, in accordance with implementations of the present disclosure. The computer system 1000 can be the server machine 130-140 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1018, which communicate with each other via a bus 1040.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1005 (e.g., forrendering an animation of a 3D object) for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1020 (e.g., a speaker).

The data storage device 1018 can include a non-transitory machine-readable storage medium 1024 (also computer-readable storage medium) on which is stored one or more sets of instructions 1005 (e.g., for rendering 3D objects) embodying any one or more of the methodologies or functions described herein. The instructions can also reside, completely or at least partially, within the main memory 1004 and/or within the processor 1002 during execution thereofby the computer system 1000, the main memory 1004 and the processor 1002 also constituting machine-readable storage media. The instructions can further be transmitted or received over a network 1030 via the network interface device 1008.

In one implementation, the instructions 1005 include instructions for predicting channel lineup viewership. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
providing, by a processing device, a first rendering of a first three-dimensional (3D) object and a second rendering of a second 3D object to a client device;
receiving, by the processing device, one or more requests for a first update to the first rendering of the first 3D object and a second update to the second rendering of the second 3D object;
determining, by the processing device, a first update priority score for the first update and a second update priority score for the second update; and
updating, by the processing device, at least one of the first rendering of the first 3D object or the second rendering of the second 3D object based on the first update priority score for the first update and the second update priority score for the second update.

2. The method of claim 1, wherein the first 3D object and the second 3D object are included in a virtual space that includes a third 3D object associated with the client device, and wherein determining the first update priority score for the first update and the second update priority score for the second update comprises:
determining a first level of visibility of the first 3D object from a vantage point of the third 3D object and a second level of visibility of the second 3D object from the vantage point of the third 3D object,
wherein the first update priority score determined for the first update exceeds the second update priority score determined for the second update responsive to the first level of visibility exceeding the second level of visibility.

3. The method of claim 1, further comprising:
receiving, from the client device, a prediction made by the client device of one or more updates to at least one of the first rendering of the first 3D object or the second rendering of the second 3D object;
comparing the one or more updates of the prediction made by the client device to at least one of the first update to the first rendering of the first 3D object or the second update to the second rendering of the second 3D object; and
determining an accuracy of the prediction made by the client device based on the comparison of the one or more updates to the at least one of the first update to the first rendering of the 3D object or the second update to the second rendering of the second 3D object,
wherein one or more of the first update priority score or the second update priority score is determined based on the determined accuracy.

4. The method of claim 3, wherein the prediction made by the client device is obtained based on one or more machine learning models associated with the client device, and wherein the method further comprises:
responsive to determining that the accuracy of the prediction made by the client device does not meet an accuracy threshold, providing an indication of the first update to the first rendering of the first 3D object to the client device for training the one or more machine learning models associated with the client device.

5. The method of claim 1, wherein determining the first update priority score for the first update and the second update priority score for the second update comprises:
providing first data associated with the first update and second data associated with the second update as input to a machine learning model, wherein the machine learning model is trained to indicate, based on given input data associated with updates to renderings of 3D objects, an update priority score for updating the renderings of the 3D objects at client devices connected to a platform;
obtaining one or more outputs of the machine learning model; and
extracting the first update priority score and the second update priority score from the one or more outputs of the machine learning model.

6. The method of claim 5, wherein the first 3D object is associated with a first additional client device connected to a platform via a network and is included in a virtual space that includes one or more other 3D objects, the one or more other 3D objects comprising at least the second 3D object, and wherein the first data associated with the first update comprises one or more of:
a level of visibility of the first 3D object from a vantage point of at least one of the one or more other 3D objects,
a time period since the first rendering of the first 3D object has been updated for the client device,
a number of 3D objects of the one or more other 3D objects having vantage points that include the first 3D object,
a degree of motion associated with the first update to the rendering of the first 3D object in the virtual space,
an audio level of audio associated with the first 3D object,
a distance between the first 3D object and the one or more other 3D objects in the virtual space,
a distance between the first 3D object and a 3D object of interest by the one or more other 3D objects in the virtual space, or
an accuracy of a prediction by the client device of a motion of the first 3D object.

7. The method of claim 1, wherein updating at least one of the first rendering of the first 3D object or the second rendering of the second 3D object based on the first update priority score for the first update and the second update priority score for the second update comprises:
adding the first update and the second update to an update queue associated with the client device, wherein the first update and the second update are added to the update queue according to an ordering based on the first update priority score and the second update priority score; and
executing one or more operations to update the at least one of the first rendering of the first 3D object or the second rendering of the second 3D object according to the ordering of the update queue.

8. The method of claim 7, wherein the first update priority score for the first update exceeds the second update priority score for the second update, and wherein the first update is added to a region of the update queue associated with a higher ordering than a region of the update queue to which the second update is added.

9. The method of claim 8, wherein updating at least one of the first rendering of the first 3D object based on the first update or the second rendering of the second 3D object based on the second update according to the ordering of the update queue comprises updating the first rendering of the first 3D object based on the first update prior to updating the second rendering of the second 3D object based on the second update.

10. The method of claim 7, further comprising:
receiving an additional request for a third update to the first rendering of the first 3D object;
determining a third update priority score for the third update;
removing the first update from the update queue; and
adding the third update to the update queue, wherein the third update is added according to the ordering based on the third update priority score.

11. The method of claim 1, wherein the first 3D object comprises a first component of a virtual avatar associated with an additional client device and the second 3D object comprises a second component of the virtual avatar associated with the additional client device.

12. The method of claim 1, wherein the first 3D object comprises a first virtual avatar associated with a first additional client device connected to a platform and the second 3D object comprises a second virtual avatar associated with a second additional client device connected to the platform.

13. A system comprising:
a memory; and
a processor communicatively coupled to the memory, the processor to perform operations comprising:
providing a first rendering of a first three-dimensional (3D) object and a second rendering of a second 3D object to a client device;
receiving one or more requests for a first update to the first rendering of the first 3D object and a second update to the second rendering of the second 3D object;
determining a first update priority score for the first update and a second update priority score for the second update; and
updating at least one of the first rendering of the first 3D object or the second rendering of the second 3D object based on the first update priority score for the first update and the second update priority score for the second update.

14. The system of claim 13, wherein the first 3D object and the second 3D object are included in a virtual space that includes a third 3D object associated with the client device, and wherein determining the first update priority score for the first update and the second update priority score for the second update comprises:
determining a first level of visibility of the first 3D object from a vantage point of the third 3D object and a second level of visibility of the second 3D object from the vantage point of the third 3D object,
wherein the first update priority score determined for the first update exceeds the second update priority score determined for the second update responsive to the first level of visibility exceeding the second level of visibility.

15. The system of claim 13, wherein the operations further comprise:
receiving, from the client device, a prediction made by the client device of one or more updates to at least one of the first rendering of the first 3D object or the second rendering of the second 3D object;
comparing the one or more updates of the prediction made by the client device to at least one of the first update to the first rendering of the first 3D object or the second update to the second rendering of the second 3D object; and
determining an accuracy of the prediction made by the client device based on the comparison of the one or more updates to the at least one of the first update to the first rendering of the 3D object or the second update to the second rendering of the second 3D object,
wherein one or more of the first update priority score or the second update priority score is determined based on the determined accuracy.

16. The system of claim 15, wherein the prediction made by the client device is obtained based on one or more machine learning models associated with the client device, and wherein the operations further comprise:
responsive to determining that the accuracy of the prediction made by the client device does not meet an accuracy threshold, providing an indication of the first update to the first rendering of the first 3D object to the client device for training the one or more machine learning models associated with the client device.

17. The system of claim 13, wherein determining the first update priority score for the first update and the second update priority score for the second update comprises:
providing first data associated with the first update and second data associated with the second update as input to a machine learning model, wherein the machine learning model is trained to indicate, based on given input data associated with updates to renderings of 3D objects, an update priority score for updating the renderings of the 3D objects at client devices connected to a platform;
obtaining one or more outputs of the machine learning model; and
extracting the first update priority score and the second update priority score from the one or more outputs of the machine learning model.

18. The system of claim 17, wherein the first 3D object is associated with a first additional client device connected to a platform via a network and is included in a virtual space that includes one or more other 3D objects, the one or more other 3D objects comprising at least the second 3D object, and wherein the first data associated with the first update comprises one or more of:
a level of visibility of the first 3D object from a vantage point of at least one of the one or more other 3D objects,
a time period since the first rendering of the first 3D object has been updated for the client device,
a number of 3D objects of the one or more 3D objects having vantage points that include the first 3D object,
a degree of motion associated with the first update to the rendering of the first 3D object in the virtual space,
an audio level of audio associated with the first 3D object,
a distance between the first 3D object and the one or more other 3D objects in the virtual space,
a distance between the first 3D object and a 3D object of interest by the one or more other 3D objects in the virtual space, or
an accuracy of a prediction by the client device of a motion of the first 3D object.

19. A non-transitory computer readable storage medium comprising instructions for a server that, when executed by a processing device, cause the processing device to perform operations comprising:
providing a first rendering of a first three-dimensional (3D) object and a second rendering of a second 3D object to a client device;
receiving one or more requests for a first update to the first rendering of the first 3D object and a second update to the second rendering of the second 3D object;
determining a first update priority score for the first update and a second update priority score for the second update; and
updating at least one of the first rendering of the first 3D object or the second rendering of the second 3D object based on the first update priority score for the first update and the second update priority score for the second update.

20. The non-transitory computer readable storage medium of claim 19, wherein the first 3D object and the second 3D object are included in a virtual space that includes a third 3D object associated with the client device, and wherein determining the first update priority score for the first update and the second update priority score for the second update comprises:
determining a first level of visibility of the first 3D object from a vantage point of the third 3D object and a second level of visibility of the second 3D object from the vantage point of the third 3D object,
wherein the first update priority score determined for the first update exceeds the second update priority score determined for the second update responsive to the first level of visibility exceeding the second level of visibility.

21. A computer program comprising instructions which, when the program is executed by a computer, cause the computer to carry out the method of claim 1.
